(19) United States
(12) Patent Application Publication
(10) Pub. No.: US 2011/0247214 A1
(43) Pub. Date: Oct. 13, 2011

(54) METHODS FOR FORMING PROGRESSIVE ALIGNERS

(75) Inventor: Scott A. Huge, Cumming, GA (US)

(73) Assignee: SPECIALTY APPLIANCE WORKS, INC., Cumming, GA (US)

(21) Appl. No.: 13/076,073

(22) Filed: Mar. 30, 2011

Related U.S. Application Data
(60) Provisional application No. 61/342,038, filed on Apr. 8, 2010.

(51) Int. Cl. B23P 17/04

(52) U.S. Cl. 29/896.11

(57) ABSTRACT

Improved methods and apparatus for forming a series of progressive aligners. A virtual model may be manipulated in a virtual CAD environment to arrive at an activated iteration of the virtual model representing progressively improved positions of one or more virtual teeth. From the virtual model, a positioning guide may be created (e.g., through the use of CAD CAM techniques to produce a corresponding positioning guide). The positioning guide may be registered to the physical model such that model teeth may be positioned according to the positioning guide to arrive at an activated iteration of the physical model. An aligner may then be generated using the activated iteration of the physical model. This process may be repeated for a variable number of iterations until the treatment objectives are determined to be met.

### CROSS-REFERENCE TO RELATED APPLICATIONS

This patent application claims priority to co-pending U.S. Provisional Patent Application Ser. No. 61/342,038, entitled “IMPROVED METHODS FOR FORMING PROGRESSIVE ALIGNERS,” filed on Apr. 8, 2010, and the entire disclosure of which is incorporated by reference in its entirety herein.

### FIELD

The present invention disclosed herein relates to improved methods for forming a series of progressive aligners to achieve specific goals of an orthodontic treatment plan.

### BACKGROUND

Traditional orthodontic armamentarium can be divided into a number of broad groups. One group is the familiar “railroad-track” metallic-type “braces” developed primarily in the U.S. With traditional braces, tooth movement is achieved by slowly dissipating energy stored in various types of tooth-borne springs. Again broadly speaking, another group is the European functional-type of appliance that achieves correction of tooth position through modulation of the gentle outward pressure of the tongue with the inward pressures of the facial musculature, cheeks and lips.

A third and newer category of orthodontic appliance is known as the orthodontic aligner. FIG. 1 depicts an example of a typical orthodontic aligner 10.

Orthodontic aligners may be characterized as thermo-formed polymeric shells presenting a plurality of tooth-receiving cavities. U.S. Pat. No. 5,975,893 to Chishti et al. and assigned to Align Technology, Sunnyvale, Calif. (now Santa Clara, Calif.), addresses an orthodontic treatment philosophy based on a series of progressive aligners. The '893 patent, along with other patents and related applications controlled by Align Technology, address various facets of aligner-based treatment. Align Technology has developed a commercial program that provides orthodontists and dentists with an aligner fabrication service known as Invisalign®. In recent years aligner-based therapy, through Align Technology's Invisalign® program, has become popular with orthodontists and their patients.

How does this newer type of appliance move teeth? Developing an understanding of the principles of aligner-based tooth movement may begin by reviewing the early work of H. D. Kesling. In 1949, U.S. Pat. No. 2,467,432 to Kesling addressed the tooth positioner—an orthodontic appliance and treatment philosophy that achieves tooth-moving functions much like today's aligners. FIGS. 2A-2G depict representative examples of orthodontic appliances and treatment philosophies discussed in the '432 patent (reproductions from figures in the '432 patent).

Even though Kesling's tooth positioners 100 (e.g., FIG. 2G) were bulky and reportedly unpleasant, they nonetheless introduced what was believed to be a new approach to tooth movement. The precepts of Kesling's philosophy have endured and remain operative in the clear, thin aligners of today (e.g., such as those of the type depicted in FIG. 1). The principles for achieving tooth movement introduced by Kesling's tooth positioners may be utilized by the aligners fabricated in accordance with the present invention to be discussed below, and therefore merit further review.

The standard methods for fabricating a tooth positioner 100 (e.g., FIG. 2G) began by taking standard alginate impressions of a patient's upper and lower arches. After taking the impressions, a slurry of fine gypsum-based plaster was poured into the impressions, and after curing, resulted in positive plaster models 110a, 110b corresponding to the patient's upper and lower dentition, palate and gums, respectively. Reference may generally be made herein to a model 110, which may refer individually to a model of a maxillary arch or mandibular arch, or may refer collectively to a model of a maxillary arch and mandibular arch.

Next, a process was undertaken where each of the stone “teeth” 120 of the models 110 were carefully cut free from the adjacent teeth 120 and from the model base using fine-tooth saws and other standard dental laboratory tools. Next, using a heated dental wax material 130, the individual teeth 120 were “waxed-in.” In other words, the teeth 120 were placed back into position on the model base in approximately the same location and orientation that they originally occupied before they were cut free. Being set in wax 130 in this manner, all of the individual stone teeth 120 that had been cut from the model 110 in this manner could be manipulated and repositioned after the entire model 110 was heated to an intermediate temperature. Once heated, the individual stone teeth 120 would become mobile within the heat-softened wax 130.

For forming a tooth positioner 100 (shown in FIG. 2G), the waxed-in teeth 120, once mobile, were moved manually through the heated wax 130 into corrected positions. This was accomplished through a combination of gross movements of groups of teeth 120 as well as exact positioning of individual teeth 120. According to those methods, the anterior segments 140a, 140b of both arches could be shaped, and the teeth 120 inclined outward or inward as needed through very slight repositioning. In essence, through these steps, an upper and lower model 110a, 110b could be produced representing the occlusion as it would appear at the end of successful orthodontic treatment; an ideal result.

The series of operations directed to the patient's models 110a, 110b and performed by skilled orthodontic laboratory technicians is known as the process of “resetting a model.” The resetting of models 110 in this manner was not developed as part of the process for fabricating tooth positioners 100. In fact, the process of resetting models 110 is identical to the process used for fabricating what is/was known as a “diagnostic set-up.” Orthodontists and orthodontic support laboratories were accustomed to fabricating diagnostic set-ups before the emergence of tooth positioner-based therapy, which initiated at least as early as the late 1940's.

Diagnostic set-ups are still used by orthodontists today as a diagnostic tool for difficult cases. A diagnostic set-up serves to diagnose difficult orthodontic cases that present multiple problems. For example, a case exhibiting an Angle Class II malocclusion, along with a deep bite, a midline discrepancy and lower anterior crowding, along with narrow and constricted arches may be considered to be a challenging case. An orthodontist, faced with the task of creating a treatment plan for such a case may employ a diagnostic set-up as a valuable reference. Such a tool can help the doctor create a visual treatment objective (VTO) and help determine the best sequence for tackling the problems. In an orthopedic sense, a diagnostic set-up may reveal a deficient relationship between the teeth and the supporting bone, helping the doctor determine if extractions are required.

Whether creating a reset model 110 for casting a tooth positioner 100, or making a diagnostic set-up, the laboratory operations were/are identical. FIGS. 3A-3M represent a series of views to better communicate the nature of the above-noted resetting process. While FIGS. 3A-3M depict only one portion of model 110, the same process may be performed individually for a maxillary arch model 110a or a mandibular arch model 110b, or may be performed on both a maxillary arch model 110a and a mandibular arch model 110b. FIG. 3A illustrates the nature of the abrasive grinding-away of the individual stone teeth 120 of a model 110. FIG. 3B depicts the wax 130 being sculpted to not only serve in holding the teeth 120 in position, but also to replicate the natural contour of the gums and soft tissue. FIGS. 3C and 3D show a check being performed while the teeth 120 are being cut free. A gauge 150 is being used to determine if a saw cut is sufficiently deep. FIG. 3E reveals the typical fine tooth saw cuts 160 made between the stone teeth 120, where as little of the model 110 as possible is removed, and the cuts 160 are made in careful compliance with the anatomy and contact relationship of the two adjacent crowns of teeth 120. FIG. 3F depicts a model 110 that has been uniformly heated, and a suck-down template 170 is positioned on all of the teeth 120 (the template 170 may be formed from a “clear” material, so the teeth 120 may remain visible even with the template 170 being positioned thereon). It is important to note that such templates 170 are formed on the model 110 before the teeth 120 are cut free and saved for this step. As the template 170 is positioned down onto the heated and mobile waxed-in teeth 120, each of the template's 170 tooth-receiving cavities 172 engages its respective tooth 120. The anatomical features of each stone tooth 120 seek to comply with the flexible but firm shape of the tooth-receiving cavity 172 and in doing so, the tooth's root viscously moves through the heat-softened wax 130 allowing the tooth 120 to arrive back at its original position that the tooth 120 was in prior to being cut free. Such movements can be considered bodily movements or a rotation-type movement around a vertical axis or a rotation around any horizontal or inclined axis and any combination of these movements that may be required for a tooth 120 to orient itself passively in intimate compliance with its tooth-receiving cavity 172 of the template 170. FIGS. 3G and 3H depict a horizontal reference datum line 180 that was marked on the teeth 120 before they were cut free from each other and from the model base. The reference datum 180 serves later in the process as a visual reference indicating to what degree the teeth 120 have moved from their original positions in terms of the reference line 180, which was straight as it was originally drawn.

As stated, tooth positioner-type appliances 100 (e.g., FIG. 2G) were fabricated using a laboratory procedure based on the patient's reset models. For the next step in that process, the reset models 110a, 110b were oriented in an occluding posture relative to each other, and slightly open (e.g., as depicted in FIG. 2D). While held in that relationship, the models 110a, 110b were surrounded with a reusable mold material. The entire assembly consisting of the models 110a, 110b positioned as described, and the reusable mold material was placed in a pressure flask. Within the flask, the components of natural rubber were introduced, which vulcanized within the void spaces between the oriented models 110a, 110b. The result was a finished tooth positioner-type appliance 100 as those shown in FIG. 2G.

FIG. 2G corresponding to Kesling's '432 patent disclose a typical tooth positioner 100. Such positioners 100 were formed as one piece of material, with the tooth-receiving cavities 102 for the upper teeth on the upper side and cavities 104 for the lower teeth on the lower side.

Progressive positioners 100 could and may in fact have been formed from reset models 110a, 110b based on several incremental activations of the mal-occluded stone teeth 120 (e.g., such as the incremental activations depicted in the progression of FIGS. 2A-2C). In other words, the laboratory technician would have moved the teeth 120 to their final position incrementally in several sessions. Each model resetting session would provide the basis for one positioner 100 of a series, accomplished in steps rather than in one gross movement.

It is interesting to note that even though the Invisalign® program uses highly automated CAD CAM rapid prototyping means for creating the patterns on which today's progressive aligners 10 (such as those depicted in FIG. 1) are formed, it would be quite feasible to form today's aligners 10 on progressively reset models 110. So, activations of the reset models 110 can accomplish essentially the same goal of positionally biasing the tooth-receiving cavities, whether accomplished digitally/virtually or in the laboratory by the manual process of heating wax 130 and manually moving stone teeth 120.

Referring back to the discussion of positioners 100, in Kesling's writings he made the points that tooth positioners 100, being formed of rubber, were quite compressible and ductile, and were capable of a considerable repositioning range. As such, a single positioner 100 alone may have been fully capable of treating some cases of mild to intermediate difficulty from start to finish. However, it is very likely that Kesling and his followers did in fact employ tooth positioners 100 in what would today be called a progressive manner. Kesling, in a 1946 article in the American Journal of Orthodontics and Oral Surgery titled “Coordinating the pre-determined pattern and tooth Positioner with conventional treatment”, did indeed allude to what would today be called progressive positioner use:
“In selected cases it has been practical to use one or more positioners to direct the eruption of the permanent teeth as well as to make slight corrections of teeth already erupted without the use of any conventional appliance. There have been several closed bite cases that have been carried to a successful conclusion without the use of any appliance other than the tooth positioning appliance”.
   In retrospect, it is probably a realistic assumption that had tooth positioners 100 been as straightforward and inexpensive to form as today's aligners 10 are, that tooth positioner-based therapy would have more uniformly been adopted as a progressive treatment regime like that currently used for aligners 10. However, it is again likely that in the past, skilled positioner practitioners did in fact use multiple positioners 100 in a progressive manner for at least some of their most difficult and stubborn cases.

In the late 1950's another orthodontist interested in utilizing the full treatment range of tooth positioners used multiple positioners formed from a single, progressively reset model to treat his cases. Orthodontist Dr. Birney Bunch, in an article titled: Orthodontic Positioner Treatment during Orthopedic Treatment for Scoliosis in the March 1961 American Journal of Orthodontics describes treating patients with progressive positioners. Dr. Bunch reported that one of his patients required five positioners. Dr. Bunch's patients suffered destructive orthodontic sequelae from orthopedic appliances worn as part of corrective spinal treatment. Utilization of progressive tooth positioner-based therapy was very beneficial to Dr. Bunch's patients.

Moving on, the forgoing description of the tooth positioned fabrication process still may not fully answer a reader's question: “How do/did tooth positioners move teeth?” To describe that, the reader must keep in mind that tooth positioners 100 (e.g., FIG. 2G) were formed from a soft compressible rubber material. At least some of the tooth-receiving cavities 102, 104 of a tooth positioner 100 were positionally biased away from their original positions or stated differently, away from their undesirable pre-treatment positions. The intent and methods for such repositioning of the tooth-receiving cavities 102, 104 is described below in more complete detail.

Orthodontists, in planning their cases would typically find that certain of the tooth-receiving cavities 102, 104 planned in a positioner 100 would register with living teeth that were already in correct and desirable positions. Such teeth then did not require repositioning and therefore they were not intended to be moved by the positioner 100. For those desirably positioned teeth, the corresponding tooth-receiving cavities 102, 104 formed in a positioner 100 would engage those teeth intimately, but passively. As such, as a desirably-positioned tooth became fully seated within its corresponding rubber cavity 102, 104, there would be no positional dissonance, and the rubber material surrounding such a tooth would be slightly compressed, gripping equally on all sides. In other words, a correctly positioned tooth would not “see” any net vector force after being ensconced within its rubber cavity 102, 104.

For those teeth that were pre-determined to require repositioning, the positioner's corresponding tooth-receiving cavity 102, 104 would demonstrate positional dissonance and be positionally biased in a manner that would urge the living tooth in a direction toward its correct position and to orient itself in or toward its correct inclination. The reader can now better appreciate the relationship between the repositioning of the stone tooth 120 of the patient's model 110 (FIGS. 3A-M) and the corresponding positionally biased cavity in the positioner 100.

In this manner then, a net force vector is delivered to the teeth of the patient requiring repositioning. The elastomeric properties of the rubber material provided sufficient ductility, allowing for compression on one side of a tooth with little or no compression on the opposite side. This then created the gentle but continuous biological forces required to initiate tooth movement.

Patients in treatment with tooth positioners 100 would typically be instructed to wear their positioner 100 for a prescribed period of time. The length of time was determined by the compressibility of the rubber material and its ability to maintain effective biological forces against teeth. The positional biasing of the cavities 102, 104 of the positioner 100 could not be too aggressive, otherwise patient discomfort and possible injury to the supporting bone could occur.

Tooth positioners 100 found their most practical use at the end of conventional braces-based treatment where they were used for final aesthetic positioning of the teeth of a patient. In such treatment situations, the actual distance of activation was typically small, and one single positioner 100 served well for final positioning after the braces and bands were removed.

As stated earlier, today's aligners 10 (e.g., FIG. 1) utilize the same methods for achieving physiological tooth movement as did the tooth positioners 100 (e.g., FIG. 2G). That is, the tooth-receiving cavities of modern aligners 10 are positionally biased in the same manner used for tooth positioners 100 beginning at least sixty years ago. Today's aligners 10, like tooth positioners 100, depend on the ductility and resilience of the appliance's material to store energy. The positioner 100, using the soft compressible properties of its vulcanized rubber structure would compress against teeth much like the finely-calibrated mechanical flexing of the thin, but more rigid polymeric shell of modern aligners 10.

Improvements to positioner-based therapy were brought forward by other orthodontists. Referring now to U.S. Pat. No. 4,793,803 to Dr. Martz, which issued in 1988, Martz' improvements were embodied by individual positioners for each arch (i.e., the maxillary and mandibular arch separately). Martz' 803 patent included this text:
“The elastic positioners of the present invention are separate single units for the upper and lower jaws molded of rubber, elastomeric material or thermoplastic or other suitable materials which cover the upper and lower teeth simultaneously and hold the jaws in a slightly open position. The units may also be used one at a time.”
   Martz brought forth other features and improvements that allowed separate upper/lower positioners to be more consistently retained in position on the teeth of a patient. For retention, Martz introduced devices that were attached (bonded) to the teeth that matingly engaged reverse-shaped embedded features in a corresponding positioner. FIGS. 4A-4I (reproduced from figures of the '803 patent) generally depict such devices in the form of attachments 91. The attachments 91, (referred to as “buttons” in the '803 patent) and correspondingly shaped reversed features on the corresponding upper/lower positioned, together held the positioner in a fully seated position while also providing greater control of forces delivered to individual targeted teeth. As shown in FIG. 4A, the attachment 91 of Martz' 803 patent is bonded to a particular tooth. Martz' methods included embedded metallic or hard plastic clasp-like devices within the elastomeric structure of his aligner/positioner that engaged features of the tooth-borne attachments 91.

Another practitioner, Dr. George Kaprelian reported even earlier use of individual upper and lower positioners in a journal article.

Another contributor to the positioner art was a relative of H. D. Kesling; Peter C. Kesling. U.S. Pat. No. 3,724,075 to Peter Kesling, which issued in 1973, introduced other types of embedded devices that served to enhance the retentive qualities of positioners. FIGS. 5A-5F (reproduced from figures of the '075 patent) depict various different representations of embedded devices 150, 150′, and 150′ and positioners 100′ according to the '075 patent.

Other additions to the tooth positioner art include the contributions of U.S. Pat. No. 4,370,129 to Huge in 1983. The '129 patent responded to the reality that some teeth ensconced within the tooth-receiving cavities of a positioned are easier to reposition than others. For example, anterior teeth with smaller single roots require less corrective force than molars with three or four large roots to achieve a given rate of tooth movement. The surface area of the crowns versus the roots of the teeth varies. Huge disclosed a positioner casting process that provided a dual durometer positioner 100″ shown in FIG. 6 (reproduced from the '129 patent). In such a positioner 100″, a harder, more forceful elastomeric material 192 formed the posterior tooth receiving cavities and a softer, gentler material 194 formed the anterior portions. Huge's casting process was the first to produce variable forces by controlling the resiliency of the materials used to form a tooth positioner 100″.

Like others, U.S. Pat. No. 4,505,672 to Kurz addressed separate upper and lower positioners 100a, 100b, such as those depicted in FIGS. 7A and 7B (reproduced from figures of the '672 patent). In combination, Kurz's '672 patent also disclosed inter-arch alignment features such as guideways 22 and magnets as well as retentive clasps 24 and features 18 for engaging elastics 16.

U.S. Pat. No. 4,856,991 to Breads et al. disclosed even more improvements to positioner-type appliances. FIGS. 8A and 8B (reproduced from figures of the '991 patent) depict representative examples of a system for use of such appliances 100′″. Breads introduced small coupling members 28, which were secured to the teeth. Bread's positioner 100′″ included complementary indentations 46, 50 that nestingly accepted Breads' coupling members 28. These features, according to Breads, were intended to help the positioner 100′″ “direct the teeth to their predetermined orientation.”

Earlier above it was stated that it is a thoroughly viable proposal to fabricate today's modern aligners 10 (e.g., FIG. 1) in much the same way that the older positioners (e.g., FIG. 2G) were formed, using the patient's reset and progressively activated models as forming patterns (e.g., FIGS. 3A-M). The factor allowing this as an option is the availability of specialized laboratory equipment. Specifically, a machine known as the BioStar®, available from Scheu Dental GmbH, is the primary means for thermoforming aligners 10. Essentially, Kesling's use of vulcanized rubber has been supplanted by the advent of the thermoforming capabilities of BioStar®-type machines, which are in use today in dental laboratories around the world.

BioStar® machines are used to thermoform sheets of thin clear plastic such as is used for forming aligners 10. Within a BioStar® machine, flat plastic sheet material is positioned directly above a reset model and the plastic sheet material is heated to a pre-determined temperature. Once sufficiently heated, air pressure is applied to a chamber above the heated material, forcing it downward into tight contact with all of the biological features of the model. All of the patient's dental realities are thereby reproduced precisely in the resulting thermoformed plastic shell forming the aligner 10.

From all of the forgoing, the reader can better appreciate the various improvements and advances incorporated into positioners. Due to these contributions through the years, we have the modern aligner used today. Further, the reader can understand that a series of progressive aligners could be produced by performing a series of operations using reset stone models where the stone teeth are sequentially moved during a series of wax-heating and tooth moving iterations. A set of progressive aligners results from these steps as formed on a BioStar® machine in the orthodontic laboratory.

It can be said that whether considering a laboratory technician activating a reset model to cast a rubber tooth positioner, or a laboratory technician activating a reset model to thermoform one of a series of aligners, that technician is faced with a list of very complex challenges. Those challenges involve how and the degree to which the heated and mobile teeth are to be moved. Those challenges involve a need for specific types of information. The nature of the information needed by the technician can be described as follows:
1.) The technician must be able to identify the basic class of malocclusion exhibited by the case and at the same time generally assess what movements of individual teeth or groups of teeth are needed to accomplish improvements to correct the occlusion.
2.) In addition to determining the vector in which teeth are to be moved, the matter of the increment of the movement is an equally important consideration. Should an individual tooth be moved 0.3 mm, 0.5 mm or 0.8 mm, for example? Small teeth require reduced forces whereas large teeth require heavier forces. The resilience of the aligner material, determined by the polymer and its thickness, impact the determination of “how far” the stone tooth is to be activated. Even factors such as the patient's age, gender and holistic health considerations can come to play in such decisions. In the text of the '803 to Martz, Dr. Martz characterized the challenge faced by the technician:
   “The technician uses judgment and experience to know how far the teeth may be moved and what types of movements can reasonably be accomplished by the positioner appliance.”
3) A technician must make an overall assessment of the case in terms of how many aligners, in total, a case will require to achieve the orthodontist's treatment objectives. Will those objectives require only three aligners, or will the case require five, for example? Is the case coming along according to the planned schedule? Are the upper and lower arches proceeding together? Overall case planning sets the pace for many incremental decisions.
4) During any one resetting iteration, a technician may need to consider previous iterations, or even look back to the original untreated occlusion. Being able to “step back” to earlier iterations to study more closely where a particular tooth originated is one of the “visualization” capabilities the technician must utilize.

As can be fully appreciated given the preceding list of challenges, a laboratory technician must weigh a very complex set of criteria as he or she activates a reset model for the purpose of forming any one in a series of progressive aligners. An individual technician must possess a variety of specialized skills and must possess an understanding of the physiology of tooth movement, along with an artist's flair for working with the stone teeth set in heated wax. Further, the technician must combine an anticipatory approach in addition to these skills in order to achieve the treatment objectives for the case. In that sense he or she must be able to look both forward and backward in time.

### SUMMARY

A first aspect of the present invention is directed to a method of fabricating an orthodontic aligner. A physical model of a patient's dental arch is acquired in any appropriate manner. The physical model may include what may be characterized as a “model tooth” that corresponds with each actual tooth of a patient's dental arch. A virtual model is produced of the patient's dental arch. The virtual model includes what may be characterized as a “virtual tooth” that corresponds with each actual tooth in the patient's dental arch as well. The virtual model is processed to allow for the individual or independent movement of at least one of its virtual teeth—a particular virtual tooth may be moved into an appropriate position without affecting the position of any of the other virtual teeth, assuming of course that a sufficient spacing exists. In this regard, one or more of the virtual teeth are moved to create a first activated iteration of the virtual model. The virtual teeth that are moved in this manner may be characterized as being members of a first virtual tooth set, and the remaining virtual teeth (those that are not being moved for purposes of this first activated iteration of the virtual model) may be referred to as being members of a second virtual tooth set. In any case, a first positioning guide is produced or fabricated from the first activated iteration of the virtual model. This first positioning guide is then used to create a first activated iteration of the physical model, which includes applying the first positioning guide to or positioning the first positioning guide on the physical model. A first aligner is then produced or fabricated using the first activated iteration of the physical model in at least some manner.

A number of feature refinements and additional features are applicable to the first aspect of the present invention. These feature refinements and additional features may be used individually or in any combination. The following discussion is applicable to at least the first aspect.

The physical model and virtual model associated with the first aspect may be an at least substantial morphological replication of the patient's mandibular arch and/or the maxillary arch. However, it should be noted that the method of the first aspect may be executed individually in conjunction with each of the patient's mandibular arch and maxillary arch—the steps set forth above may be undertaken for the patient's mandibular arch, and furthermore may also be undertaken for the patient's maxillary arch. An aligner may be fabricated for each of the patient's mandibular arch and maxillary arch, and these aligners may be simultaneously worn by the patient.

The acquisition of the physical model may be undertaken in any appropriate manner for purposes of the first aspect. One option for acquiring the physical model is for the same to be received (e.g., via shipment) from another party (e.g., an orthodontist). Another option is for this acquisition to entail producing the physical model. The physical model may be produced in any appropriate manner. One embodiment has this production being in the form of creating a stone model of the patient's dental arch (e.g., using a gypsum slurry to fill impressions of the patient's dentition or the like as discussed above). Another embodiment has this production being in the form of using rapid prototyping to create the physical model.

The physical model of the patient's dental arch may be processed to allow for the individual or independent movement of at least one of the model teeth—a particular model tooth may be moved into an appropriate position without affecting the position of any of the other model teeth. Any appropriate number of the model teeth may be “released” from the remainder of the physical model to allow for independent movement thereof, including without limitation the case where all of the model teeth are released from a base of the physical model.

The above-noted processing of the physical model may be characterized as a “resetting” of the physical model. Model teeth that are “released” may be separated from the remainder of the physical model in any appropriate manner (e.g., using an appropriate saw or other appropriate tooling), and thereafter may be subjected to grinding as desired/required. In any case, each model tooth that has been “released” may then be “re-attached” to the physical model (e.g., a base thereof) in any appropriate manner (e.g., by “setting” such a model tooth in heated dental wax or the like, such that when the dental wax cools, the model teeth that are partially embedded therein are then maintained in position). Thus, the resetting of the physical model may occur prior to the creation of the first activated iteration of the physical model.

A retainer or template aligner may be produced for the physical model prior to undertaking the above-noted processing of the physical model. This retainer or template aligner would thereby be a “negative morphological replication” of the original physical model. After the physical model has been processed in the above-noted manner, the retainer or template aligner may be positioned on the physical model to present the plurality of model teeth at least substantially in their original, pre-processed position. For instance, the physical model may be heated to soften the above-noted wax, and the template aligner may be seated on the physical model. Each model tooth that is not in its original position should be moved back at least substantially to its original position by seating the template aligner on the physical model.

The creation of the first activated iteration of the physical model may be undertaken after the physical model has been processed in the above-noted manner. In any case, the first activated iteration of the physical model again entails using the first positioning guide. In one embodiment and with the first positioning guide already being properly positioned on or applied to the physical model, one or more of the model teeth may be individually and manually moved such that a particular model tooth is moved into contact with a corresponding portion of the first positioning guide (e.g., after heating the physical model to allow the model teeth to move within the softened dental wax in which they may be partially embedded). This movement of a particular model tooth may be in the lingual direction to come into contact with the corresponding portion of the first positioning guide (e.g., in the direction of a patient's tongue). This movement of a particular model tooth may also be in the facial direction to come into contact with the corresponding portion of the first positioning guide (e.g., in the direction of a patient's cheek or lips). The term “facial” or the like encompasses each of the terms “labial” (a term that is used to designate a surface or side that is opposite of the lingual for certain teeth) and “buccal” (a term that is used to designate a surface or side that is opposite of the lingual for certain other teeth). Each model tooth, whose corresponding virtual tooth was moved to create the first activated iteration of the virtual model (or stated another way, each model tooth having a corresponding virtual tooth that is in the first virtual tooth set), may be moved to create the first activated iteration of the physical model.

The above-noted “corresponding portion” of the first positioning guide may be referred to as a “reference datum”, a “stop”, or a “face”. That is, it may define a desired position for a corresponding model tooth for purposes of the first activated iteration of the physical model (and which should at least substantially correspond with the first activated iteration of the virtual model). However, and as noted, movement of this particular model tooth is required in order for it to assume this position. In one embodiment, the “corresponding portion” of the first positioning guide is a reference datum, stop or face that coincides with entire mesio-distal extent of the corresponding model tooth. Stated another way, the stop on the first positioning guide for a particular model tooth may be of the same width as this model tooth.

Another option for creating the first activated iteration of the physical model entails moving at least some of the model teeth in response to the actual positioning or application of the first positioning guide to the physical model. The relative movement between the first positioning guide and the physical model may produce a movement of at least some of the model teeth to create the first activated iteration of the physical model. In one embodiment, the first positioning guide may include a cavity that corresponds with and/or that is sized to receive the patient's dental arch (e.g., at least generally U-shaped). This cavity may be characterized as a collection of individual and interconnected tooth receptacles, where each such tooth receptacle is for or accommodates an individual model tooth.

Additional features may be utilized by the above-noted first positioning guide, where the act of positioning the same on the physical model induces movement of at least some of the model teeth to provide the first activated iteration of the physical model. In one embodiment, this particular first positioning guide includes an anterior section, a first posterior section for a first arch side of the physical model (e.g., corresponding with the left side of a posterior portion of the patient's dental arch), and a second posterior section for a second side of the physical model (e.g., corresponding with the right side of this same posterior portion of the patient's dental arch). The anterior section may correspond with the centrals, laterals and cuspids of the patient's dental arch. Each of the posterior sections may correspond with the first and second molars of the corresponding side (left or right) of the patient's dental arch. The positioning guide may include one or more additional sections. For instance, between the noted anterior and posterior segments may be left or right buccal segments, which in a permanent dentition includes the first and second bicuspids. In any case, the anterior section, the first posterior section, and the second posterior section may be separate guide structures and independently movable. Therefore, each of the anterior section, the first posterior section, and the second posterior section may be independently applied and moved relative to the physical model. Features could be incorporated to facilitate the alignment of the anterior section, the first posterior section, and the second posterior section relative to each other and/or to achieve a proper position relative to the physical model, to interconnect the same at least when in the proper position relative to the physical model, or any combination thereof.

Although each of the virtual teeth could be moved to create the first activated iteration of the virtual model, typically such will not be the case. Those virtual teeth that are moved to create the first activated iteration of the virtual model again may be characterized as being in a first virtual tooth set. Those virtual teeth that are not moved to create the first activated iteration of the virtual model again may be characterized as being in a second virtual tooth set. The first positioning guide may be registered to the physical model using some of or each of the model teeth of the physical model that has a corresponding virtual tooth in the second virtual tooth set. This registration may occur prior to moving any of the model teeth of the physical mode for purposes of creating the first activated iteration of the physical model. The first positioning guide may interface with at least one of a facial surface and a lingual surface of each model tooth of the physical model having a corresponding virtual tooth in the second virtual tooth set, and this interfacing relationship may exist along the entire mesio-distal extent of a particular model tooth. Therefore, the first positioning guide may interface with both a facial surface and a lingual surface of each model tooth of the physical model having a corresponding virtual tooth in the second virtual tooth set, or the first positioning guide may interface with either a facial surface or a lingual surface of each model tooth of the physical model having a corresponding virtual tooth in the second virtual tooth set.

The virtual model may be produced in any appropriate manner. For instance, the virtual model may be created by scanning a physical model of the patient's dental arch. Moreover, the virtual model may be created by directly scanning the patient's dental arch or by scanning the negative spaces of an impression of the dental arch. Any appropriate scanning technique may be utilized, including without limitation laser scanning, triangulated digital photography, computerized tomography, by the use of a Coordinate Measuring Machine (CMM), or any combination thereof.

The creation of the virtual model may be characterized as acquiring a data set that at least substantially replicates the patient's dental arch. The creation of the virtual model may be characterized as creating a digital data file that is stored in digital memory. The virtual model may be in the form of a digital computer file that represents a complete morphological duplicate or replication of the patient's dental arch. The creation of the virtual model (e.g., by scanning a physical model) may occur prior to the resetting of the physical model described above.

The processing of the virtual model may “release” or “separate” any appropriate number of its virtual teeth, including without limitation each of the virtual teeth. The processing of the virtual model may be undertaken in any appropriate manner, as may the creation of the first activated iteration of the virtual model. In one embodiment, these manipulations of the virtual model are undertaken using three-dimensional solids-based CAD software (e.g., using an appropriate computer with the noted software). Data for producing the first positioning guide may be acquired from the first activated iteration of the virtual model. For instance, a CAD file that is generated from the first activated iteration of the virtual model may be used by computer-aided machining (CAM) software to fabricate/produce the first positioning guide in any appropriate manner.

Various forms of first positioning guides may be fabricated and in any appropriate manner. One embodiment has the first positioning guide being in the form of a thin, plate-like structure (e.g., a thickness of no more than about 1 mm (0.040″) having a cavity that extends through its entire thickness for receiving the entirety of the dental arch of the physical model. The distance between any corresponding lingual and facials edges or boundaries of this cavity, at a position corresponding with a model tooth that will be moved to create the first activated iteration of the physical model, may be greater than the spacing of the lingual and facial surfaces of this same model tooth. As such, the first positioning guide may be positionable on the physical model without causing such a model tooth to move. Stated another way, each model tooth that is to be moved to create the first activated iteration of the physical model may be spaced from at least one of a lingual and facial edge or boundary of the first positioning guide that defines the noted cavity when the first positioning guide is initially positioned on and registered to the physical model. The lingual and facial edges or boundaries of the first positioning guide that define the noted cavity may be in the form of a knife edge or the like (e.g., to provide “edge” contact between the first positioning guide and the physical model).

A single first positioning guide of the above-note type (e.g., a “thin” version) may be utilized to create the first activated iteration of the physical model. Another option would be to utilize multiple first positioning guides of the above-noted type (e.g., each being a “thin” version), for instance where a pair of such first positioning guides would be spaced in the occlusal/gingival dimension when applied to or positioned on the physical model for subsequent creation of the first activated iteration of the physical model.

Each model tooth of the physical model will typically be in contact with a corresponding portion of the first positioning guide after the creation of the first activated iteration of the physical model. In one embodiment, these interfacing surfaces of the first positioning guide present a two-dimensional surface or two-dimensional reference datum (e.g., versus the above-noted “knife edge”). For instance, these interfacing surfaces of the first positioning guide may have an occlusal/gingival extent. In one embodiment, the first positioning guide has a thickness within a range of about 2 mm to about 3 mm, where the thickness dimension corresponds with the occlusal/gingival dimension when the first positioning guide is applied to or positioned on the physical model. A first positioning guide of this enhanced thickness may be positioned on the physical model so as to be positioned occlusally or gingivally of the Andrew's plane.

Another variation of the first positioning guide is to define the same to have at least two different surfaces, where each such surface interfaces with a different morphological surface (e.g., a lingual surface, an occlusal surface, a facial surface) of its corresponding model tooth of the physical model. The first positioning guide could have a cavity defined by a facial surface that extends along the entirety of the dental arch of the physical model, an occlusal surface that extends along the entirety of the dental arch of the physical model, and a lingual surface extends along the entirety of the dental arch of the physical model. The type of first positioning guide described in this particular paragraph may be of the type referred to above, where the act of placing the first positioning guide on the physical model itself causes one or more of the model teeth to move to create the first activated iteration of the physical model.

The first positioning guide may include a number of features to facilitate its use in the first aspect of the present invention. Various indices may be provided on one or more of its top and/or bottom surfaces. Calibrated anterior-posterior and left-right millimeter grids can be provided on the first positioning guide. The first positioning guide may also include a centerline or midline, reference lines coinciding with the reference cuspid angles, or the like. These types of features may provide a reference to assist a laboratory technician in repositioning the physical teeth of the physical model.

An aligner is fabricated based upon the first activated iteration of the physical model. This may be undertaken in any appropriate manner. For instance, an aligner may be formed directly on the first activated iteration of the physical model (e.g., using the above-noted type of BioStar® machine).

It should be appreciated that the first aspect may be repeated any appropriate number of times to provide any appropriate number of aligners. In one embodiment, a second activated iteration of the virtual model may be produced, using the first activated iteration of the virtual model as a “baseline” of sorts. It may be desirable to produce/retain multiple copies of the data for each of the various virtual models. Moreover and as discussed above, an aligner for the patient's mandibular arch may be produced in accordance with the first aspect in conjunction with an aligner for the patient's maxillary arch. The first positioning guides described herein themselves may correspond with a separate aspect of the present invention.

Further aspects of the present invention will be addressed, including in relation to some illustrative graphics. The present invention applies to the actual repositioning or resetting step and provides physical means for planning, coordinating, measuring, documenting and archiving cases. The present invention and devices permit the progressive aligner fabrication process to be broken into a hierarchy of tasks, allowing those tasks to be delegated to a team of specialists. The team can be based on those most skilled in the art to plan a case and then for specialists to handle actual fabrication steps. The present invention involves methods and improved means for laying out the progressive aligner treatment sequence and in particular improved means for activating a patient's stone, or physical model. The methods and devices of the present invention reduce the complexity and serve to simplify the vexing challenges faced by the orthodontic laboratory technician using conventional methods.

Being more specific, a central benefit of the present invention is that its use enables an experienced and skilled master technician to lay out and plan cases and to make the difficult cross-functional and interdisciplinary decisions necessary to successfully support the objectives of the treating orthodontist. Once a case has been interpreted, planned and laid out, execution of many of the steps can be delegated to other technicians with more specialized expertise, allowing those technicians to produce very high-quality progressive aligners capable of achieving excellent results. With the master technician positioned to interpret, plan and lay-out cases, and other technicians positioned to work directly at aligner fabrication for example, the entire process of fabricating progressive orthodontic aligners becomes more efficient and more precise.

### BRIEF DESCRIPTION OF THE DRAWINGS

FIG. 1 is a perspective view of an orthodontic aligner from the prior art.

FIGS. 2A-2G are various views of a prior art positioner and models for fabricating the same.

FIGS. 3A-3M are various views depicting a series of operations to produce a reset model.

FIGS. 4A-4I are various views of prior art devices for use in conjunction with another prior art positioner.

FIGS. 5A-5F are various views of another prior positioner and devices for use in conjunction therewith.

FIG. 6 is a perspective view of a dual durometer prior art positioner.

FIGS. 7A and 7B are views of separate upper and lower prior art positioners.

FIGS. 8A and 8B are views of a prior art positioner and devices for use in conjunction therewith.

FIG. 9 is a perspective view of an embodiment of a virtual model existing in a CAD environment.

FIG. 10 is a perspective view of an embodiment of a positioning guide.

FIG. 11 is a top view of the embodiment of the positioning guide shown in FIG. 10 aligned with a physical model.

FIG. 12 is a perspective view of the embodiment of the positioning guide shown in FIG. 10 aligned with a physical model.

FIG. 13 is a perspective view of a portion of another embodiment of a positioning guide.

FIG. 14 is a perspective view of a portion of the embodiment of the positioning guide shown in FIG. 13 in position relative to a model tooth of a physical model.

FIG. 15 is a perspective view of a slice of a virtual model.

FIG. 16 is a perspective view of a segment of the slice shown in FIG. 15, and corresponding to a tooth of the virtual model.

FIG. 17 is a perspective view of the segment of FIG. 16 according to an embodiment with Cartesian planes intersecting the segment.

FIG. 18 is a perspective view of the segment of FIG. 16 with a plurality of representative vectors corresponding to examples of possible bodily movements of the segment.

FIG. 19 is a perspective view of the segment of FIG. 16 with a plurality of representative vectors corresponding to examples of possible rotational movements of the segment.

FIG. 20 is a perspective view of the segment of FIG. 16 with a plurality of representative vectors corresponding to other examples of possible bodily movements of the segment.

FIG. 21 is a perspective view of a positioning guide blank according to one embodiment and prior to fabricating a positioning guide therefrom.

FIG. 22 is an enlarged view of part of the positioning guide blank shown in FIG. 21.

FIG. 23 is a perspective view of another embodiment of a virtual model existing in a CAD environment.

FIG. 24 is a perspective view of another embodiment employing at least two positioning guides in place on a physical model.

FIG. 25 is a side view of the embodiment shown in FIG. 24.

FIG. 26 is a cross-sectional view of a patient's dental arch with a positioning guide according to yet another embodiment in place on the physical model.

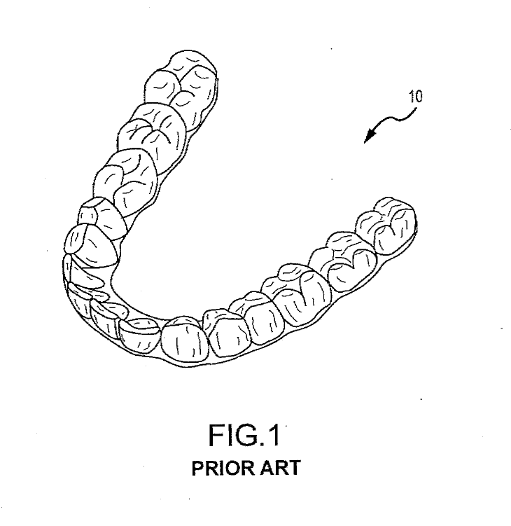

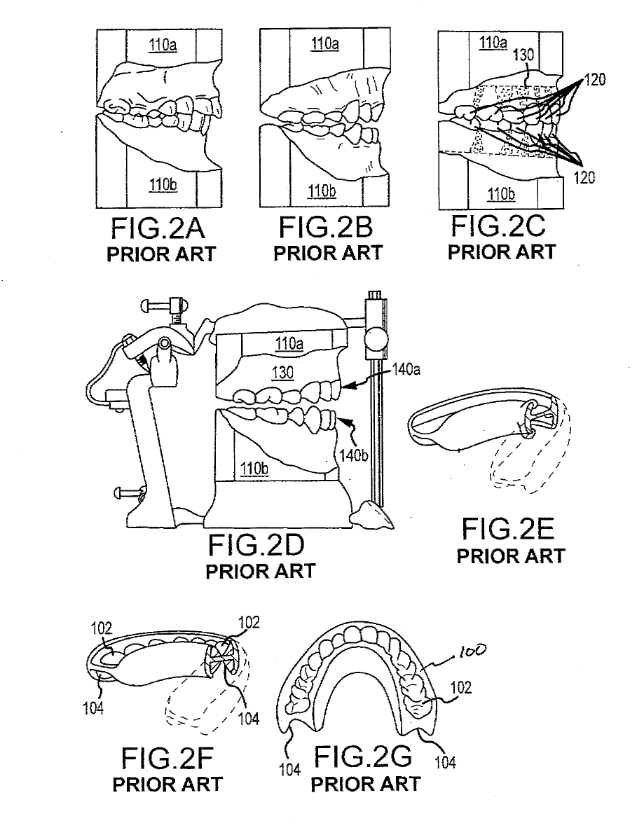

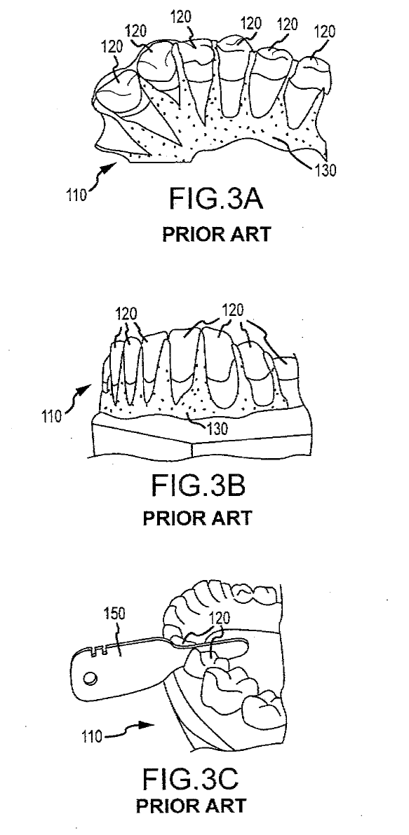

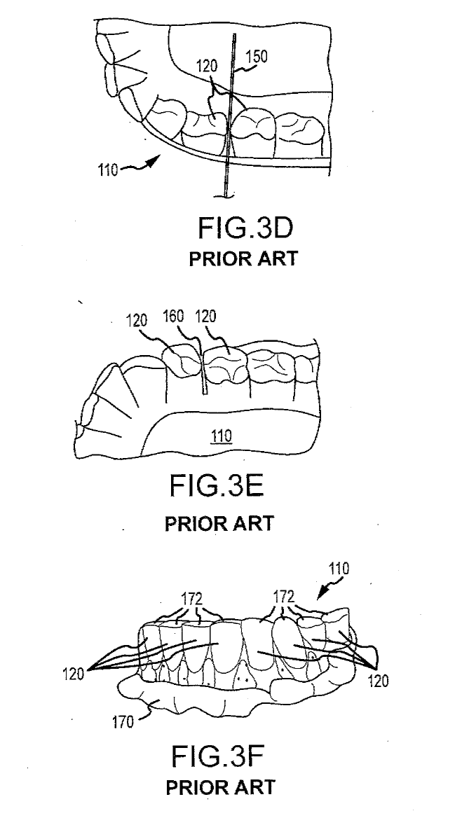

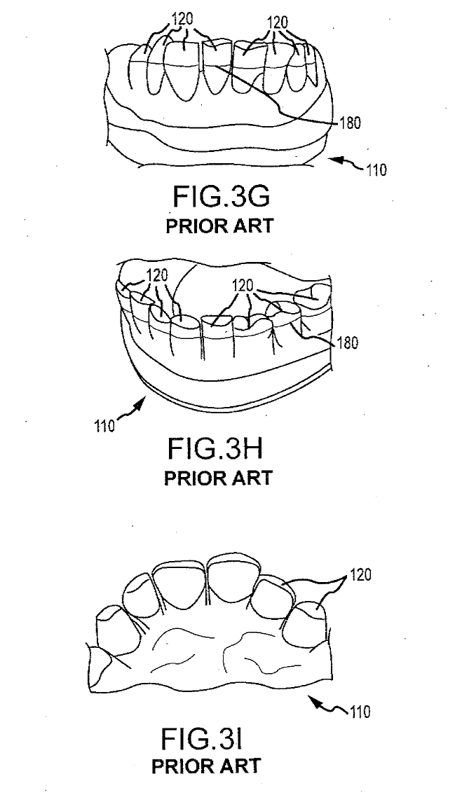

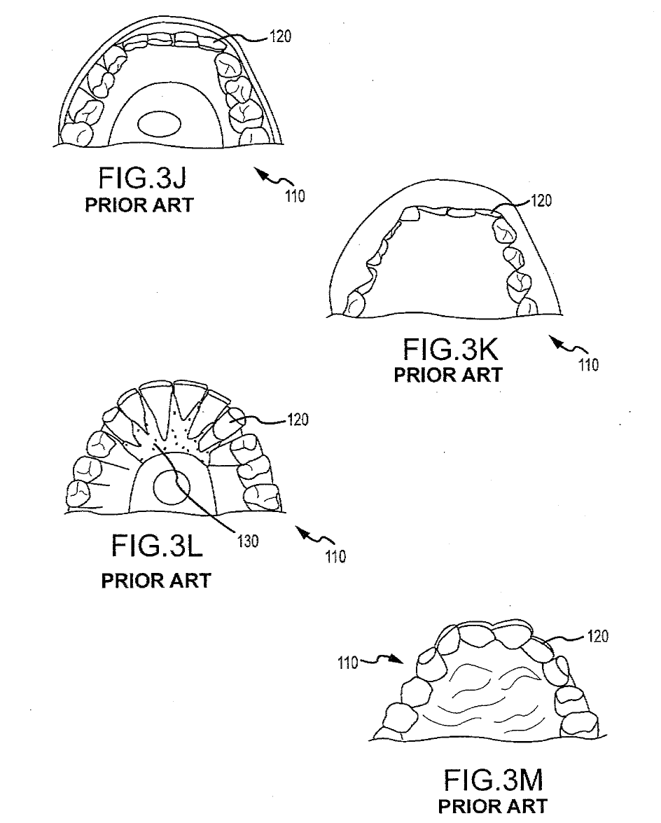

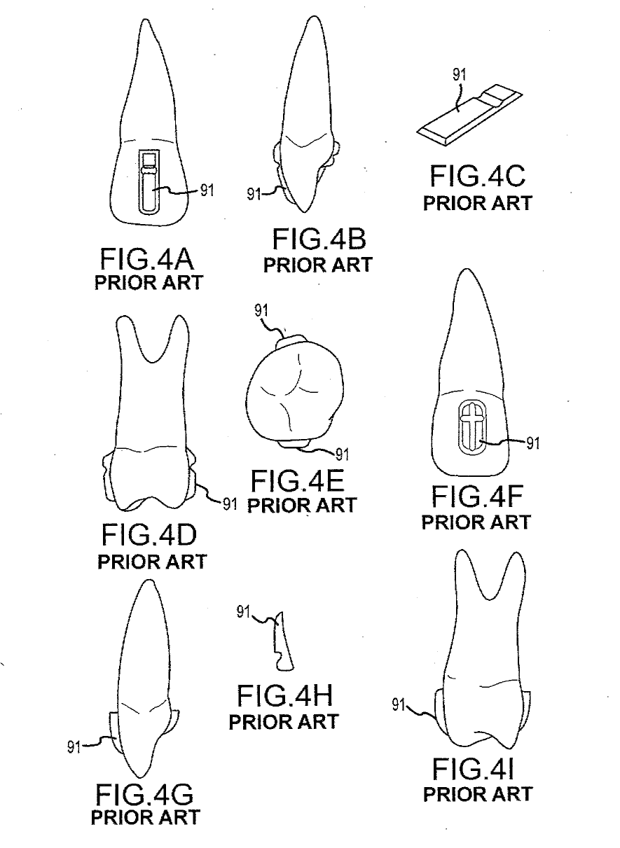

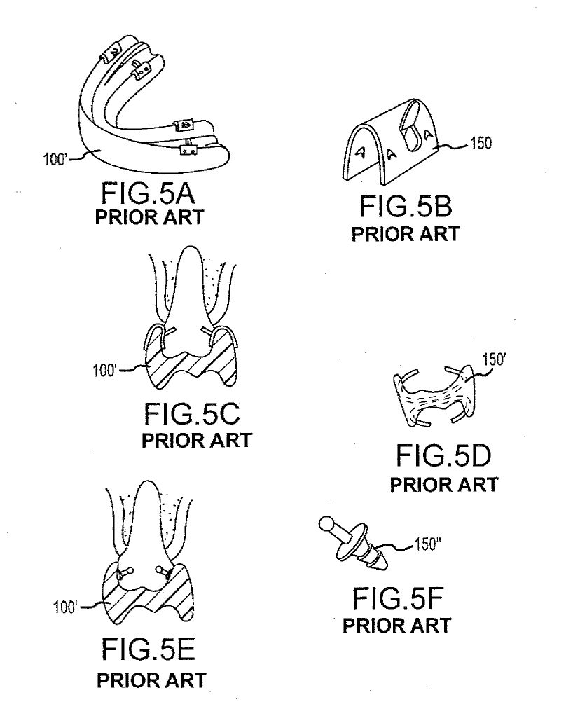

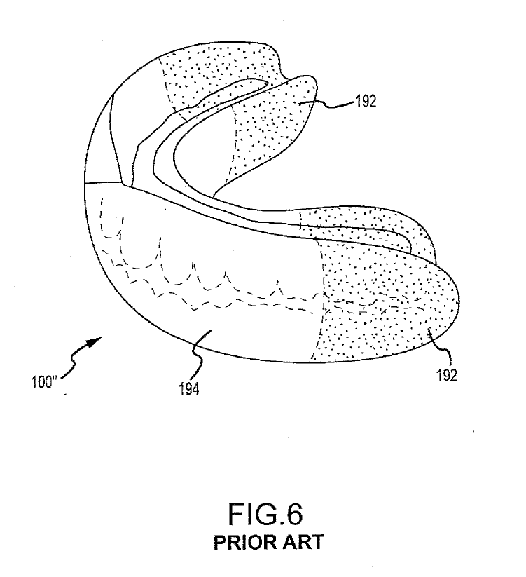

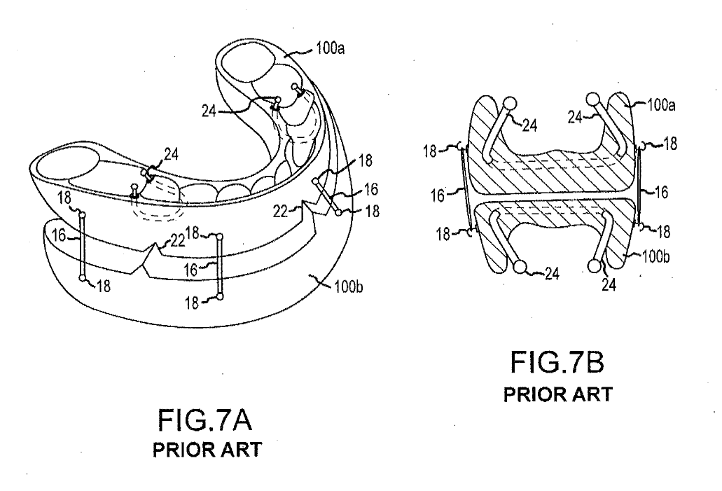

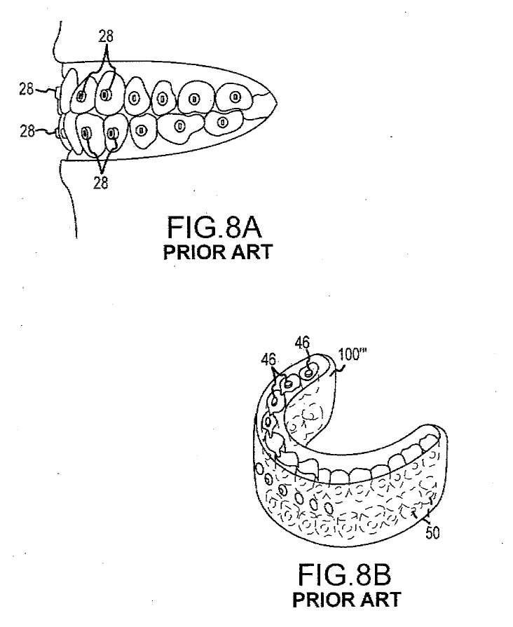

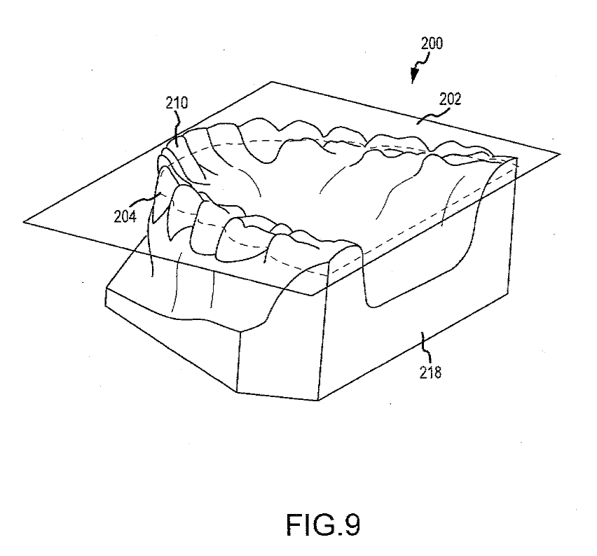

### DETAILED DESCRIPTION

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope and spirit of the invention as defined by the claims.

One embodiment of a method described herein may begin with the traditional step of taking impressions of an individual patient's teeth and the creation of a set of physical models (e.g., pouring stone models as described above for many of the related processes used over the years). In the case of an orthodontic service laboratory, the patient's physical models would normally be shipped to a laboratory by the treating orthodontist along with other specific case related information and instructions. The steps and processes described below are normally accomplished within the orthodontic service laboratory, but the entire process can be accomplished in any setting with the requisite supportive fixtures and equipment. Some orthodontists, for example, choose to establish appliance fabrication capability directly in their practice and for those practices, the present invention can be practiced in such an in-practice laboratory.

In one embodiment, the patient's physical models are subjected to a three-dimensional scanning process. Several scanning methods are currently known and routinely used in dentistry and orthodontics. Known scanning methods include laser scanning and triangulated digital photography, to name a few examples. Other means exist where the miniaturized scanning function can be incorporated into an inter-oral wand capable of directly scanning the patient's living dentition, foregoing the scanning of a physical model altogether. Other suitable processes include Computerized Tomography as adapted and sized to the dental application or the use of a Coordinate Measuring Machine (CMM).

A stone model will most typically serve as the item being scanned, but the reader should note that other types of physical models produced through one of several suitable rapid prototyping processes can also serve as the item being scanned. Should models be produced based on CAD virtual models, those models can be grown through the use of one of several known rapid prototyping processes. For example, models may be formed from laser-curing or light-curing resins such as Urethane dimethacrylate in the presence of triethylene glycol dimethacrylate, or standard olefin polymers, or combinations of wax and standard polymers as well as cyanoacrylate or epoxy-stabilized cellulosic materials. One method assumes that the models are CNC-machined from an amorphous pattern material. Other types of rapid prototyping processes may be used, for example, other three-dimensional printing techniques, fused deposition modeling, stereolithography, etc.

Returning to the initial step of scanning, it should be understood that the purpose of the scanning process is to generate a special type of digital computer file that represents a complete virtual morphological duplicate of the patient's dentition (i.e., a virtual model). Depending on the method of scanning that is employed, such files may require further processing but in all cases, the final objective of the scanning step may be the creation of a set of virtual models corresponding with the maxillary arch and/or mandibular arch of the patient's dentition that is suitable for residing in, and suitable for further manipulation within three-dimensional solids-based CAD software. For the purposes hereof, the CAD models will be called the “virtual models.”

Once the patient's models or dentition have been scanned, or stated differently, once the patient's virtual models have been obtained and are held in the virtual CAD environment, the process returns to the physical models where a set of aligners may be formed over the physical models in the standard manner using a Biostar®-type machine. For the present purposes, these first aligners can be called “template aligners” due to the special function they serve in resetting the physical model to the original state of the patient's dentition, which will be described below.

The next step for processing the patient's models according to one embodiment includes the physical models being reset, which may involve all of the actions described earlier for resetting, including cutting the individual model teeth or groups of model teeth free, and repositioning them in place on the model base using wax, etc. These steps further include sculpting the wax somewhat as required to approximate the gingival margins and soft tissues naturally present around the living teeth.

Once the resetting step is complete, the entire physical model is heated to an intermediate temperature. The reader should understand that the laboratory technician may place the warmed physical model in a “teeth-up” position on the work surface. The template aligner, which was formed in a pretreatment configuration, is placed on the model teeth and urged down onto them. As can be appreciated, positioning the template aligner on the warmed physical model serves to move the model teeth through the heat-softened viscous wax, returning them precisely to the positions they occupied prior to the cutting and resetting steps preformed on the physical model. The template aligner is left in place on the model teeth while the entire physical model cools. Once cooled, the template aligner may be removed and discarded. So, the steps to this point result in a very accurate physical model of the pre-treatment condition, represented by individual model teeth or groups of model teeth supported in wax as a reset model.

The next sequential step in an embodiment of a process involves operations on the virtual model performed by a CAD technician as he or she manipulates the virtual model within the virtual CAD environment. The CAD technician essentially duplicates the entire resetting process carried out on the physical model, but in a virtual manner with respect to the virtual model. So, just as was done for the physical model, each virtual tooth corresponding to a mal-positioned living tooth is cut free and moved relative to the other virtual teeth and the virtual model base. The reader should understand that such actions are more or less standard or routine actions, similar to the activities of CAD technicians working in the aerospace or civil engineering fields, for example. The steps of “cutting” a virtual tooth free from its virtual model and the adjacent virtual teeth and moving it to a precise, new position can be accomplished in a straight forward manner using several commercially available CAD software packages. For the current process, the CAD technician's first objective is to only cut all of the virtual teeth free from the base, but not to move them. The first goal is to replicate the patient's pretreated or original malocclusion once the virtual teeth have been separated so as to be individually manipulatable. To summarize these initial processing steps, physical reset models and virtual models have been created, both of which represent the patient's pretreatment or original malocclusion.

So after the virtual models have in effect become “reset”, matching the physical models in a state representative of the original mal-occluded position of the patient's dentition, the process returns to the virtual model and the CAD technician. Each virtual tooth requiring repositioning is repositioned into incrementally better positions, with each tooth moving toward its desired finished position and finished inclination. In accomplishing this step, the CAD technician must combine mastery of the CAD software with the skills of the lab technician. To restate comments cited earlier by Dr. Martz from the '803 patent referring to the laboratory technician's actions:
“The technician uses judgment and experience to know how far the teeth may be moved and what types of movements can reasonably be accomplished by the positioner appliance.”
   Indeed, the CAD technician may possess the skills of the laboratory technician, or he may perform CAD manipulations under the instruction of the laboratory technician. In either case, the objectives at this stage may not be to finish the case, or stated differently, the objective may not be to move the virtual teeth into any sort of final aesthetic, fully treated condition. Instead, the objective is to arrive at a first activated iteration of the virtual model representing only the first of a series of aligner iterations. The virtual tooth movements must be made according to the complex hierarchy of concerns discussed earlier, ranging from the physiological capacity of the underlying bone to support the tooth for movement, to the mechanical properties and thickness of the material intended for use when forming the first in a series of progressive aligners.

The reader may note that at this stage, no visual treatment objective has been established for the case. In other words, no diagnostically-determined finished objective has been created either virtually or physically. Even though the CAD technician, along with the laboratory technician do not benefit from being able to reference a finished version of the case treated to completion, they nonetheless can send the virtual teeth “traveling on their journey” in the correct directions that will ultimately lead to a satisfactory result. All movements are determined with skill, guided by experience to allow the initial moving of the virtual teeth to be accomplished in appropriate directions within safe and effective physiological limits.

So, continuing on with the process, once the virtual teeth have been appropriately moved by the CAD technician in accordance with all of the forgoing reference information-based considerations and instructions from the treating doctor, the resulting virtual model is saved within the CAD software, and identified as the patient's first activated iteration of the virtual model (e.g., in the form of a CAD file or the like). The first activated iteration of the virtual model is processed further according to the next step of the various sequences of embodiments, which may include the creation of a device to be referred to as a positioning guide or “guide”. The guide is created digitally using the first activated iteration of the virtual model created above. The disclosure contained herein anticipates various embodiments of guides as well as various methods for fabricating guides. Guide configurations may include, for example:
1) a thin, two-dimensional guide;
2) a thicker (e.g., 2 to 3 mm thick) guide;
3) multiple or stacked two-dimensional guides; and/or
4) a thicker guide incorporating occlusal and some lingual anatomy.

The example of a thin two-dimensional guide (corresponding to number 1 above) will be used for the following description of guide fabrication and guide use according to one embodiment. The thicker (e.g., 2 to 3 mm thick) guide, the multiple or stacked two-dimensional guides and the thicker guide incorporating occlusal and some lingual anatomy-types will be described in more detail below.

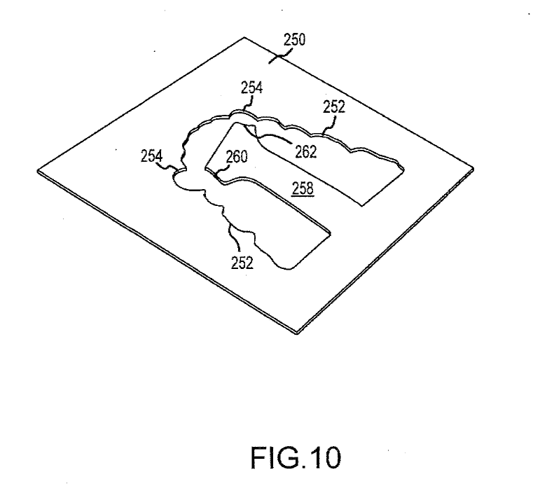

With reference to FIGS. 9 and 10, a thin, two-dimensional guide 250 may be created within the virtual CAD environment 200 by establishing a plane 202 bisecting all of the virtual teeth 210 at an appropriate occluso-gingival level on the virtual model 218. “Thin” may be used to describe a guide having a much larger width and length in dimensions corresponding to the occlusal plane than the thickness of the guide 250 in the occlusal/gingival dimension. Accordingly, such a guide 250 may have a thickness in the occlusal/gingival dimension, in some embodiments, of less than 1 mm. The plane 202 may be generally parallel to the occlusal plane or may depart from the occlusal plane or may be slightly curved “plane” according to a curve of Spee. Even though there is a possibility of being slightly curved in the virtual environment 200, the resulting physical guide 250 will be planar. The CAD technician establishes a line 204 across the labial/buccal and lingual surfaces of the crown of each virtual tooth 210 that represents the intersection of the plane 202 with the crown of each virtual tooth 210. In this regard, the two-dimensional information corresponding to the line 204 may be used in creation of a positioning guide 250.

As shown in FIG. 9, the plane 202 is shown positioned and oriented as described above. The line 204 represents the intersection of that plane 202 with the labial and buccal surfaces of the crowns of the virtual teeth 210. The line 204 may be generated automatically in the CAD software at the intersection of the plane 202 and the crowns of the virtual teeth 210. Though not shown for the sake of clarity, the reader should understand that such crown/plane intersection lines 204 may also created across the lingual sides of the crowns of the virtual teeth 210.

A thin two-dimensional guide 250 according to one embodiment is shown in FIG. 10. Such a guide 250 may be created using the first activated iteration of the virtual model 218 (e.g., using the CAD file), based on the intersection line 204 described above. That is, the positioning guide 250 may include one or more reference datums (e.g., 252, 260, or 262) defined as an edge of a continuous cavity that extends through the positioning guide 250. The reference datums 252, 260, 262 may also be referred to as “stops.” Accordingly, the stops 252, 260, 262 may correspond to facially and/or lingually disposed reference datums of the positioning guide 250 defined by the line 204 on the first activated iteration of the virtual model. The stops 252, 260, 262 may correspond to the entire mesio-distal extent of one or more virtual teeth 210 along a corresponding portion of the stop 252, 260, 262.

The guide 250 is created after further processing of the first activated iteration of the virtual model 218 using an additional type of software known as Computer Aided Machining (CAM) software. Computers that include both CAD-type software and CAM-type software are known as CAD CAM systems. The CAM output consists of code that is used to drive one of several known robotic fabrication methods, to be described below. As such, the guide represents a “slice” of the patient's virtual teeth 210 taken along the line 204 after those virtual teeth 210 have been virtually moved to the first activated iteration within the CAD software. It may be the CAM software based on the CAD-produced intersection lines 204 that is used to machine the guide 250 such that the stops 252, 260, and 262 are defined as edges of the continuous cavity correspond to at least a portion of the intersection line 204. Accordingly, the CAM software may be operable to generate machining instructions (e.g., for an automated machining tool) to remove material from the positioning guide 250 to create the stops 252, 260, and 262 defining at least a portion of the edge of the continuously extending cavity.

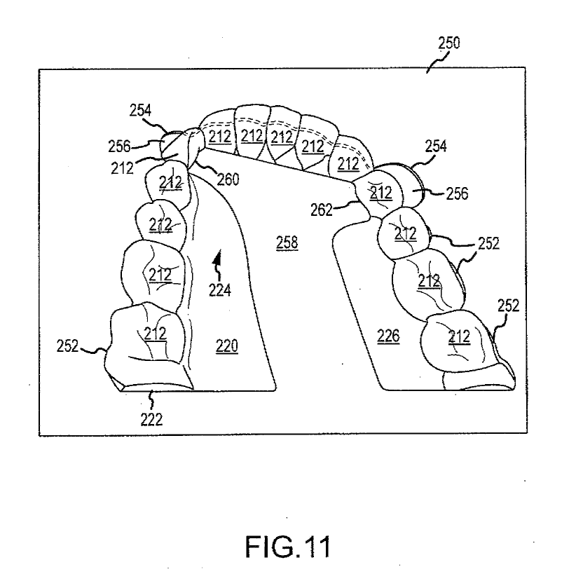

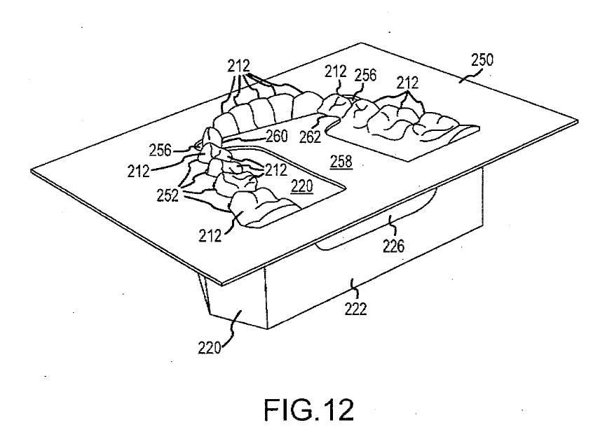

It should be noted that at this point in the process, the patient's physical model 220 (shown in FIGS. 11 and 12) remains in reserve, unaltered and in a condition representing the initial pre-treatment/untreated malocclusion. In one embodiment, the resulting guide 250 produced from the first activated iteration of the virtual model 218 is positioned on that initial reset, but as yet un-activated pre-treatment physical model 220 as shown in FIGS. 11 and 12. As such, each of the model teeth 212 of the physical model 220 may be captured by the continuous cavity of the guide 250. The guide 250 may be registered into position with the base 222 of the physical model 220, for instance by being positioned in register with one or more model teeth 212 that may not require any repositioning at this stage. That is, one or more of the model teeth 212 may not have undergone any movement in the virtual model 218 to arrive at the first activated iteration. As such, the resulting guide 250 may be register with the model teeth 212 that have not been moved in the virtual model 218. This may assist in registering the guide 250 with the physical model 220.

At least one or more of the model teeth 212 will be offset from facially or lingually disposed reference datums defined by the stops 252, 260, and 262 of the positioning guide 250. With the physical model 220 warmed, a laboratory specialist physically pushes the model teeth 212 that are offset from the guide 250 through the heated wax 226 into contact with corresponding portions of the stops 252, 260, or 262 of the guide 250 (each such model tooth 212 being moved either lingually or labially/bucally). In doing so, the model teeth 212 move into positionally-biased positions, closing the gap between their initial untreated malocclusion position and their intended first iteration positions. In turn, once the model teeth 212 have been moved into a positionally-biased position, each model tooth 212 may rest flush against a corresponding portion of a stop 252, 260, or 262 of the guide 250 along the entire mesio-distal extent of the model tooth 212.

In FIGS. 11 and 12, the guide 250, which has been registered and held fixed with the physical model 220, is shown. In typical cases, the majority of the model teeth 212 will need to be pushed outward (i.e., facially) against the guide 250 but a few model teeth 212 may need to be repositioned inward or more lingually. Edges 254 of the continuous cavity may define cut-outs 256 where the guide material 250 has been relieved to avoid interference on the labial or buccal side so that corresponding model teeth 212 can be pushed inward (i.e., lingually). The laboratory specialist may use a stylus or a dental instrument to move the heated model tooth 212 adjacent to a corresponding lingually disposed stops 260 or 262 of the guide 250 (e.g., move the model teeth 212 lingually, against the guide 250). The cut-outs 256 may be created to provide access for such tools. In a similar regard, material may be removed from the guide 250 on the lingual side of the model teeth 212 to facilitate access with a stylus or dental instrument to move model teeth 212 facially.

The guide 250 may include a structure 258 that extends into the lingual area 224 of the physical model 220 and in the example depicted has provided two lingually disposed stops 260 and 262 for the left cuspid and the right 1^{st} bicuspid, respectively. Thus, each respective model tooth 212 may be moved lingually into contact with a respective one of the stops 260 or 262 such that the model teeth 212 are in contact with a corresponding stop 260 or 262 along an entire mesio-distal extent of the respective model tooth 212.

Both the patient's upper and lower physical models 220 may be brought along together through these various steps and operations, arriving at this stage, and the wax 226 may be allowed to cool. The first upper and lower aligners may be thermoformed on a Biostar® machine at this point using the first activated iteration of the physical models 220. The resulting set of upper and lower aligners are considered to be the first aligners and represent the first set of a progressive series of aligners. The aligners may be labeled and set aside during the subsequent processing of the rest of the series as described below.

Once the first aligners are formed, the CAD technician opens the patient's virtual model 218 held within the CAD software and once again, skillfully moves one or more of the virtual teeth 210 into yet better positions and inclinations as seen on the computer monitor to arrive at a second activated iteration of the virtual model 218. Because the process to produce the second activated iteration of the virtual and physical models 218 and 220 may be substantially the same as that to arrive at the first activated iteration of the virtual and physical models 218 and 220, the description of the process may be described with reference the same figures discussed above in relation to the process to arrive at the first activated iterations of the physical and virtual models. When discussing the process to arrive at the second activated iteration the same reference used to describe the first iteration will be used. As such, the foregoing description may generally describe the process associated with all iterations of the process.

The original first activated iteration of the virtual model 218 may be closed and stored for reference, while a copy of the virtual model 218 is created for use in accomplishing the second activated iteration moves of the virtual model 218. When the CAD technician has completed these steps, the second activated iteration of the virtual model 218 is saved within the CAD computer as the patient's second activated iteration CAD files. As before, those files are then processed further through the CAM portion of the software, resulting in a CAM code file for machining the second set of positioning guides 250 (e.g., all iterations of guides herein again are identified by reference numeral 250, even though the various iterations will have different geometries). Since the guides 250 described are thin, a small 3 axis CNC milling machine or a servo-stepper-driven two-dimensional router can be enlisted for the process. The second guides 250 may then be machined.

Once machined then, the second upper and/or lower guides 250 are brought into fixed registration on the warmed physical model 220 and a laboratory specialist pushes the model teeth 212 against the corresponding stops 252, 260, 262 of the second guide 250, again moving the model teeth 212, closing the small gaps between the model teeth 212 and corresponding ones of the second guide stops 252, 260, 262 which correspond to facially or lingually disposed reference datums generated in the second activated iteration of the virtual model 218. The range of movement will typically range from 0.25 mm to 0.75 mm, but larger movements may be undertaken. Again, most of the model teeth 212 may typically be pushed outward (e.g., “facially”, corresponding with a labial movement for some model teeth 212, and corresponding with a buccal movement for other model teeth 212), while some cases may involve model teeth 212 that need to be repositioned inwardly, or lingually. It should be noted that the contoured stops 252, 260, 262 formed into the profile of a thin, two dimensional guide 250 against which the model teeth 212 are pushed may induce a desirable rotation the model tooth 212.

The initial gap then, between some model teeth 212 and the guide 250 may be seen as a tapered, curved gap present on the distal but disappearing on the mesial side, for example. When the model tooth 212 is pushed into such a stop (e.g., 252, 260, or 262 of the guide 250), the model tooth 212 may “fall” into compliance with that stop profile through a combination of rotation and tipping as well as bodily movement through the wax 226 such that the entire mesio-distal extent of the model tooth 212 contacts a corresponding portion of a stop of the guide 250. The reader will now understand that such multi-axis movements of the model teeth 212 through the wax 226 will of course be reflected in the position of the tooth-receiving compartments of the resulting aligners, and in fact, such subtle tooth repositioning represents the exact corrective movements required to treat the case.

So once again, a set of second aligners is formed from the second activated iteration of the physical model 220 after the physical model 220 is further activated through use of the second positioning guides 250. The resulting aligners formed from the second activated iteration of the physical model 220 then are considered to be the second aligner set. Like the first aligner set, these too may be labeled and set aside to wait for further processing of the series to be completed.

It may be appreciated that the steps described above fall into identical repeating cycles, for instance resulting in a third, fourth, fifth, etc. iteration set of progressive aligners and so on as each case may require. Also, while described above in relation to a process for both a maxillary arch and mandibular arch, such a process could be used individually for only one of a maxillary or mandibular arch.

Having covered the steps of each cycle in detail, it may be appreciated that the use of positioning guides 250 as a tool or template for accomplishing calibrated repositionings through the heated wax 226 and into progressively improved positions takes the responsibility for such activations out of the hands of highly skilled laboratory technician. In essence, it makes the task much easier and at the same time, much more accurate because the actual analysis and determinations for any specific tooth movement were made at the virtual CAD-level, not at the laboratory specialist-level.

The advantages in having many of the critical determinations made at the CAD-level is that, within the CAD environment, many measuring and visualization tools are available to the technician. A virtual tooth 210 of a virtual model 218 can be put into trial positions and evaluated, and then returned as a visual experiment. A CAD technician can rotate and zoom-in on certain areas of a virtual model 218 for much tighter viewing if needed. Further, the CAD technician may open and compare earlier activated iterations of virtual models 218 of the case as part of the “looking backward in time” concept covered earlier. All of these points serve to take a large portion of the responsibility for accuracy off of a laboratory specialist, meaning that activation iterations can be accomplished by laboratory personnel with less training and experience; and at the same time, more quickly. This leaves the skilled technicians to handle the important central planning and the laying out of cases, which most efficiently uses their broader skills and experience.

The reader may ask; how does the skilled technician know when the case is treated to an ideal occlusion and therefore finished? For the present purposes, we can say that ideal occlusion has various benchmark features that are familiar and recognizable to a skilled orthodontic laboratory technician. There are established statistical values for ideal tooth inclination (torque, angulation, prominence, incisal height and so on). Further, ideal occlusion involves aesthetic positions of the teeth in terms of over jet, molar relationship, arch width, arch form and more. When a case approaches a finished state, many indications confirm it.

The procedures and methods described herein expressly do not include any step of first virtually treating a case to its finished, ideal condition as is done according to the Invisalign®program, for example. Instead, each cycle of successive activated iterations using the current set of inventive methods and devices sees the overall condition of the case improve in all regards. After a sixth activated iteration, for example, the laboratory technician and the CAD technician may determine that one last activated iteration (i.e., the seventh) can correct all remaining subtle deviations from an otherwise perfect or desired result. At that point then, a seventh and final set of positioning guides 250 may be machined and corresponding aligners will be thermoformed from the final activated iteration of the physical models 220. Such a finish is arrived at much like a traveler finally arriving at the desired destination, even though the traveler may not have known the exact address of the destination when the journey began.

Above, a list of guide configurations was provided that included, for example:
1) a thin, two-dimensional guide;
2) a thicker (e.g., 2 to 3 mm thick) guide;
3) multiple or stacked two-dimensional guides; and/or
4) a thicker guide incorporating occlusal and some lingual anatomy.
   Some discussion will now be provided on fabricating other guide embodiments and their use in fabricating aligners, particularly, a thicker (e.g., 2 to 3 mm) guide.

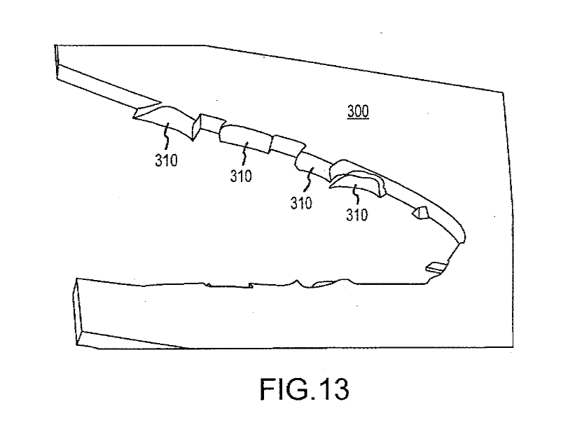

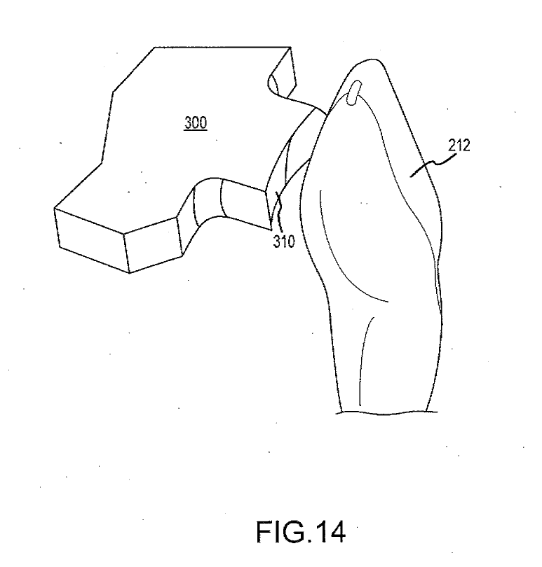

The term “torque” is known to orthodontists and is used to define the orientation of a tooth in terms of labial/buccal or labial/lingual tipping of its crown. It may be desirable for a positioning guide according to at least one embodiment to be capable of transferring torque-type positioning information to model teeth 212 being activated/repositioned. The tooth contacting stops 252, 260 and 262 of the thin, two-dimensional guide 250 described previously do not have sufficient occluso-gingival thickness to create a torquing moment as the laboratory specialist pushes the teeth against its contour (hence the guide 250 being described as a “two-dimensional” guide). That is, only two-dimensional data may be represented in the thin two-dimensional guides 250. The thin, two-dimensional guide 250 essentially presents a “knife edge”, allowing a model tooth 212 to tip in terms of torque on that edge, but as far as being able to convey a specific torque value is concerned, such capability is diminished. So, to serve those few cases that require specific torque values and to create a means for torque values to be transmitted through a positioning guide, one embodiment anticipates guides 300, as shown in FIGS. 13 and 14, with thicknesses in the range of 2 to 3 mm or thicker if special case control is required.

In order to accomplish this, a more complex approach to three-dimensional surfacing techniques is required at the virtual CAD level. Processing for the thin two-dimensional guide 250 involved a simple plane 202 being positioned appropriately and the intersection of that plane 202 with the crown surfaces of the virtual teeth 210 was created to arrive at the simple profiles for machining a two-dimensional guide 250.

For a thicker guide 300, the contours of the tooth-guiding features must exhibit true tooth anatomy-compliant faces 310. Each of the faces 310 may comprise a two-dimensional reference datum for a corresponding model tooth 212. The steps of this embodiment extend back to the scanning of the original physical model 220. To save scanning and processing time, and to reduce data storage requirements, it may be that only the dentition and a small portion of the soft tissue is scanned. The rest of the physical model 220, including a base portion as shown above with regard to FIGS. 9 and 10 can be eliminated from the scanning Later, a “generic” base portion can automatically be created if required using special CAD software adaptations based on guidelines inherent in the dentition combined with a library of pre-determined standard base shapes.

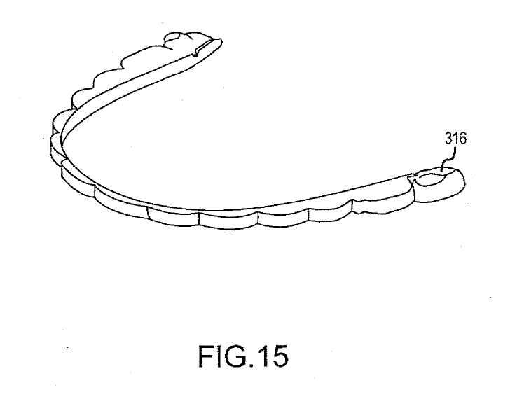

For the present description of a thicker (e.g., 2 to 3 mm) guide 300, the initial virtual models 218 are sliced in the virtual CAD environment 200 on either side of the Andrews plane, leaving a section 316 (shown in FIG. 15) of the initial virtual model 218 that is of a thickness corresponding to the guide 300 thickness in the occlusal/gingival dimension. The Andrews plane can be considered as a plane that passes through a point located at the mesio-distal and occluso-gingival center of the facial surface of each virtual tooth 210.

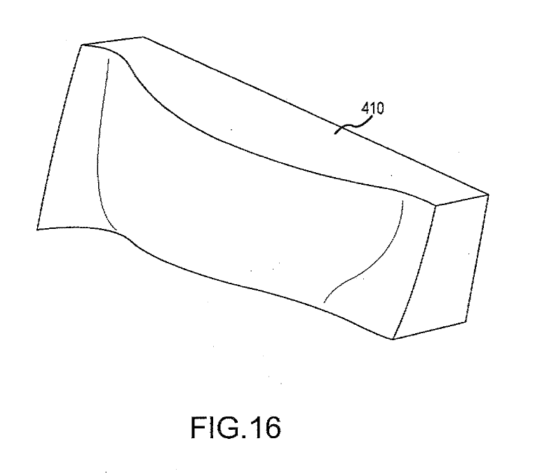

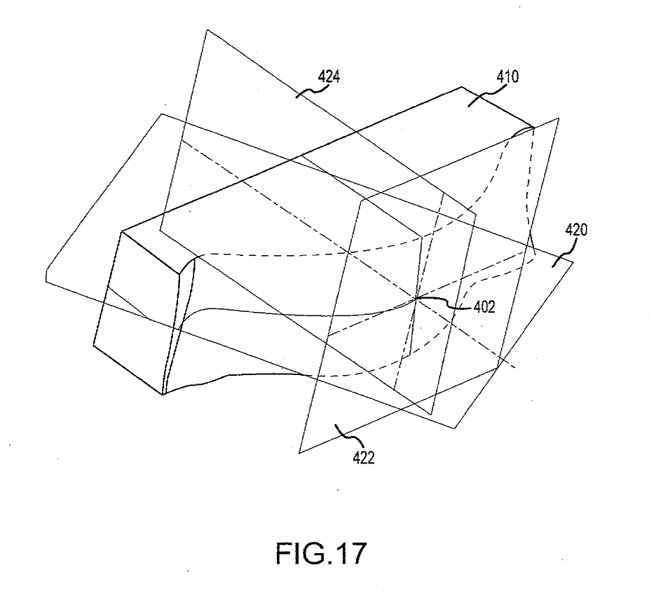

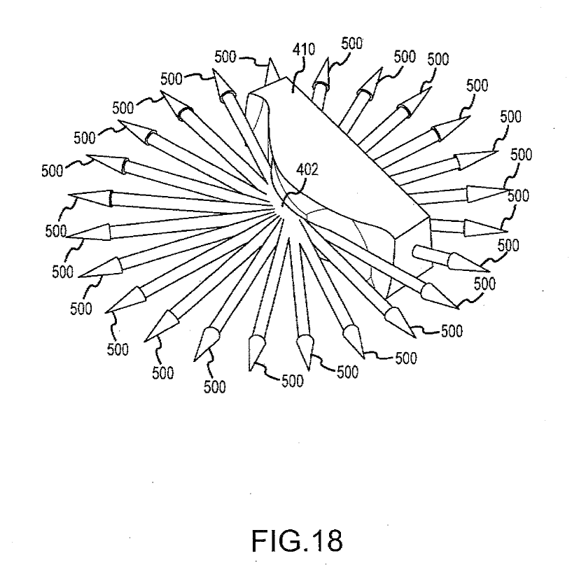

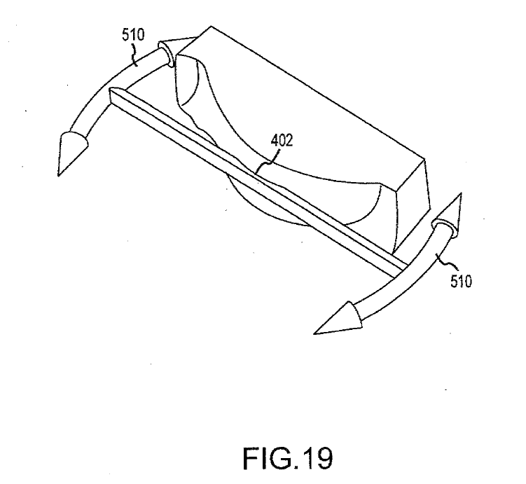

The subsequent steps of the process are described here in with reference to FIGS. 15-20 as they pertain to only one virtual tooth 212 portion 410 even though the CAD technician may handle one or more of the other virtual teeth 210 in an identical manner. For example, a portion 410 of the slice 316, corresponding to the maxillary right 1^{st} bicuspid tooth, is isolated for this discussion and is shown in FIG. 16. The maxillary right 1^{st} bicuspid tooth portion 410 of the slice 316 is bisected with Cartesian planes (420, 422, 426) as a means to locate a focal point 402 at the effective center of the labial surface of the tooth segment 410, as shown in FIG. 17. Orthodontists may refer to this focal point 402 (FIG. 17) as the siting point, a landmark used for positioning conventional brackets. The focal point 402 can be considered to be centered occluso-gingivally on the Andrews plane. The first activation step taken by the CAD technician may be to determine the corrective bodily movement required for the upper first bicuspid right tooth segment 410 according to all of the factors and considerations described in detail throughout this narrative. The entire tooth segment 410 may undergo bodily movement on any one of an infinite number of vectors 500, a limited representative number of which are shown in FIG. 18.

The slice segment 410 for the virtual tooth 210 is virtually “cut free” from the rest of the slice 316. Then it may be “dragged and dropped” by the CAD technician to its new position, using the focal point 402 as a “handle.” It is important to note that while the virtual tooth segment 410 is in translation, it may be otherwise locked in all axes from any sort of rotation and is thereby prevented from tipping or swinging as it is repositioned.

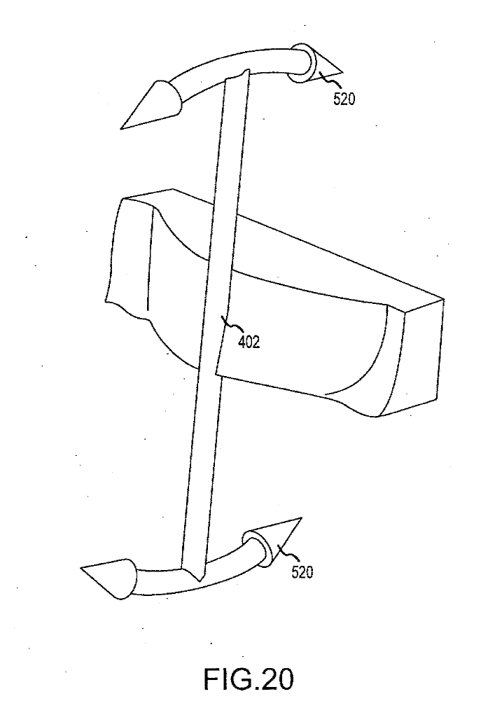

Once the tooth segment 410 slice has been bodily translated to its new position, the activation needed in terms of rotation can be addressed. Pivoting around the focal point 402, the CAD technician may rotate the tooth a few degrees clock-wise or counter clock-wise as viewed from its incisal or occlusal surface in a direction represented by arrows 510 in FIG. 19. A rotation-type activation is typically limited to no more than 2 or 3 degrees per iteration, but may undergo greater activation in certain embodiments. Next, the CAD technician may see a need to alter the inclination of the segment slice in terms of torque. Specific adjustments in terms of torque are only occasionally needed. These activations are accomplished by subtle rolling adjustments in the direction of arrows 520 shown in FIG. 20. The steps for translating the segment slice 410 bodily and then rotating the segment slice 410 around horizontal and vertical axes can be further combined with slight bodily intrusion deeper into the gum or extrusion out of the gum as well as other subtle tipping motions. All such adjustments to the position and inclination of a segment slice 410 are accomplished then for all of the segments of the slice 316 of the arch with the exception of those teeth predetermined to already be in desired positions and inclinations. In FIG. 14, a small symbolic section of a positioning guide 300 in position in front of a corresponding tooth 212 is shown.

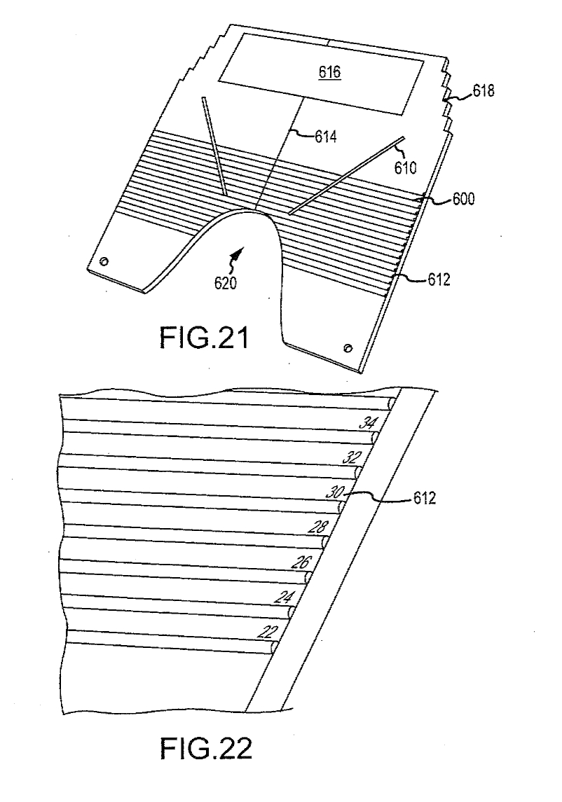

The slice segments 410 of all the teeth 212 being treated, after being manipulated as described, are all fixed or otherwise “locked down” within the three-dimensional virtual CAD space. With reference to FIG. 21, a virtual guide blank 600 may be introduced into the same virtual three-dimensional space. The virtual guide blank 600 is positioned to bisect all of the virtual slice segments 410 of the arch 316 with an approximate “best fit” positioning within the virtual CAD environment. Next, a “join” operation is performed by the CAD technician, which joins all of the seemingly chaotically oriented slice segments 410 and the virtual guide blank 600 as one amorphous part. The blank virtual guide 600, which is trimmed along the interface of the virtual guide blank 600 and each segment 410 of the slice 316, producing a virtual guide with smooth top and bottom surfaces that include anatomy compliant faces 310 corresponding to the positions of each of the segments 410 of the arch 316 in the first activated iteration of the virtual model 218. The finalized virtual guide 300 is inspected and filed appropriately within the digital memory.

The finalized virtual guide that includes information regarding the anatomical compliant faces 310 of the resultant physical guide 300 may be processed by a CAM software package in order to develop machining instructions associated with the virtual guide 300 to arrive at a corresponding physical guide 300. These machine instructions may in turn be used by an appropriate machine process produce the physical guide 300. In this regard, the physical guide 300 may be created from a physical guide blank 600.

To follow is a description of a representative guide blank 600 according to an embodiment. The guide blank 600 may be physically or represented virtually in a CAD environment with any or all of the following features. The material from which a physical guide is formed falls in the group of hard but resilient thermoset plastics such as ABS, PVC, high impact styrene, acrylic (Plexiglas) and high density polyethylene. Other non-thermoset materials may be suitable such as RenShape foamed polyurethane material, nylon or phenolic. The material must meet the requirements of being machinable at high speed, while at the same time presenting a smooth machined surface. Dimensional stability in terms of low creep and low shrink is desirable. Industrial ABS sheet material, for example, in 2.25 mm thickness would be accurately cut or injection molded into individual guide blanks (or preforms) of standardized overall dimensions of 3.5 inches×4 inches, for example.

Various types of functionality may be incorporated into the guide blank 600, which is particularly achievable if the guide blanks are produced via injection molding. The functionality may include various types of indices on its top and bottom surfaces that can be molded or engraved into the guide blank 600. Such indices can serve as useful references for the laboratory technician as the completed guide is used. For example, calibrated anterior-posterior and left-right millimeter grids 612, reference cuspid angles 610 and a centerline or mid-line 614 may be included in one embodiment of a guide blank 600, all of which can serve as references, helping the laboratory technician in repositioning the teeth 212 of the physical model 210. An area with a rougher surface 616 can be provided appropriate for hand-marking of the guide 600 using a plastic-marking pen to record such information as case number, customer number, patient name, and iteration number and the like. The roughened area 616 can be used to position a pressure sensitive bar code label, or the roughened area can be directly ink jet printed.

The guide 600 may incorporate features for accepting an RFID E-prom. The guide blank 600 may include holes-through for registration of the guide 600 on dowel pins of a fixture designed to expedite the registration of the guide 600 to physical model, positioning it as intended relative to the Andrews plane and the occlusal plane. Further, the color of the guide material 600 itself may used to convey information. Specifically, a convention may be established in an orthodontic laboratory where, for example, a green-colored set of guides may designate a case's first positioning guide iteration, yellow the second positioning guide, orange the third positioning guide and so on. It is anticipated that optically clear guides may provide advantages in use. Clear or translucent guides may be edge-lit for additional visual aid to the laboratory technician. A staggered or stepped series of “French stops” 618 may be configured into the guide's forward edges to provide registration for re-machining of the guide 600, so such guides can be “recycled” and serve for multiple cases or multiple iterations within the same case. There may be relieved areas 620 of the guide intended to reduce the overall amount of material that is required to be removed during a CNC machining step. The guides may have registration features that allow them to snap together or inter-fit with each other so that they tend to stay aligned when stacked on top of each other when in storage, for example.

Once all CAD operations are complete for the guide 300, the resulting CAD part, consisting of all the repositioned slice segments 410 and the guide blank 600 (joined as a single part) are subjected to the CAM portion of CAD CAM software. The CAM software allows the CAD technician to specify all of the parameters involved in the machining of the guide blank 600. To speed machining, large cutters are directed to remove the bulk of the material. Then, smaller cutters begin to form the details of each tooth's corresponding biologically-shaped crown faces 310. Finally, small spherical-shaped cutters known as ball-end mills are directed to a matrix of tight paths over the surfaces that are in essence, negative versions of the tooth segment's crown-contacting faces 310.

For the CNC machining step, a physical guide blank 600 is placed in a precision holder and the holder is mounted within a CNC milling machine connected to the CAD CAM system. The CNC machine spindle is registered or zeroed with a zeroing datum on the holder or preferably, zeroed on a datum on the guide blank 600 itself The appropriate CAM file for the case, generated from the CAM-processing of the virtual model 218 of the case is started, and the robotic machining of the guide blank begins.

It should be noted that the present invention anticipates processes other than CNC machining for creating finished tooth positioning guides. Several appropriate rapid prototyping processes are known, including three-dimensional wax printing, fusion deposition modeling, stereo lithography and the well-known Z-corp. process. All of these alternative means for forming the guide can be driven by the same CAD file of the virtual model 218 created according to the processes and steps described earlier.

The resulting set of positioning guides 300 (one upper, one lower) is placed on the physical models 210. The positioning guide 300 may registers precisely with those model teeth 212 that were not intended for movement such as (typically) the molars and other model teeth 212 that have been pre-determined as already being in desirable positions and inclinations. As such, with the guide 300 registering with those model teeth 212, the guide 300 falls into its precisely accurate position on the physical model 220. For those model teeth 212 that are scheduled for repositioning, there will of course be a positional difference or gap between the labial surface of the model tooth 212 and the corresponding biologically-shaped face 310 of the guide 300 as shown in FIG. 14. This gap is closed as described by the laboratory specialist after the physical model 220 is warmed in a manner as described above with regard to movement of model teeth 220 once the physical model 220 is heated to soften the wax 226. The complexity of the more CAD-intense sequence for creating the thicker guide 300 as described directly above may justify yet another approach for creating a guide capable of controlling the repositioning of the biologically shaped stone crowns specifically when torque considerations are included.

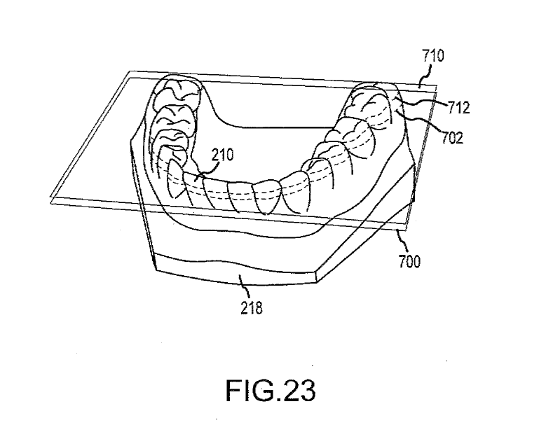

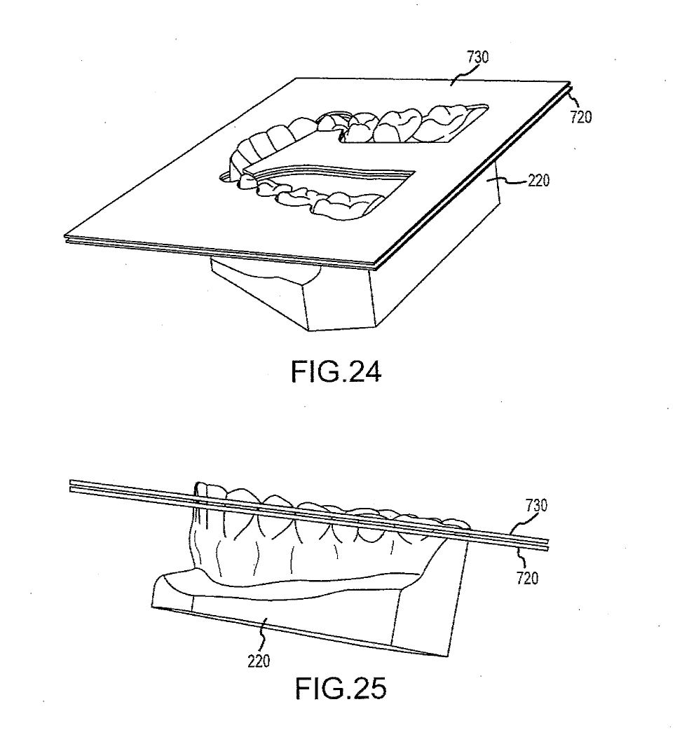

Earlier for the thin two-dimensional guide 250, it was demonstrated how a plane 202 can be appropriately positioned relative to the Andrews plane and the occlusal plane. Another approach involves creating and positioning two such planes 700, 710 in the virtual CAD environment 200 with respect to the virtual model 218 as is shown in FIG. 23. This results in two thin two-dimensional positioning guides 720 and 730 which may be used in concert as shown in FIGS. 24 and 25.

In FIG. 23, a first plane 700 and a second plane 710 can be seen in position relative to a patient's virtual model 218. The lines 702 and 712 around the virtual teeth 210 represent the intersection of planes 700 and 710 with the virtual teeth 210. Each of the lines 702 and 712 serves as the basis for a corresponding one of the two-dimensional thin guides 720 or 730 shown together in position on the virtual model 718 in FIGS. 24 and 25. The stacked combination of the two-dimensional thin guides 720 and 730 accomplishes three-dimensional control of the model teeth 212 of the physical model 220 in a manner similar to the thicker, fully surfaced guide 300, but without the intensive CAD surfacing requirements described above. This is accomplished at some expense, however, in that two guides 720 and 730 must be machined per arch instead of one.

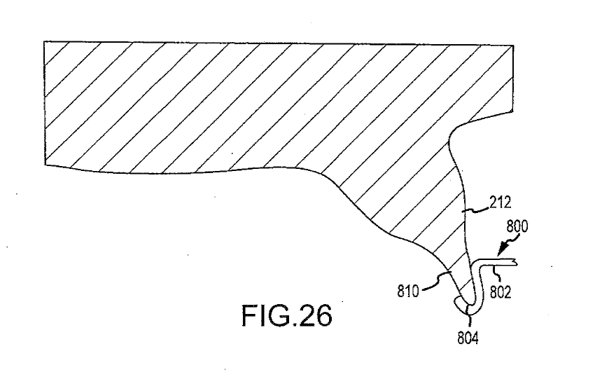

All of the guide configurations described herein require the laboratory specialist to manually push the model teeth 212 against one or more guides. In some cases, the guide has features where the force of technician's pushing, combined with spaced-apart features of the guide create a torque moment. The moment that is created is intended to swing the stone roots through the heat-softened wax. This action is intended to upright an undesirably labial or lingually tipped stone tooth in terms of torque. In fact, the forcing of the central portion of the labial face of the stone crown against corresponding biologically-shaped concave face of a guide serves to convey a complex net force vector to the mobile model tooth. One drawback to such a guide configuration is that the pushing step, performed by the specialist technician must be very firm and the force exerted may need to be maintained for an inordinately long duration. In order for the subtle “mating” of the convex biologically shaped surface of the crown of the model tooth 212 to the corresponding negative and concave face (e.g., face 310) machined into the guide to occur, the technician must be both strong and patient while the root(s) swing through the wax. To overcome these requirements, the present invention anticipates yet another guide configuration 800 partially shown in FIG. 26 that combines the facial characteristics of the thicker three-dimensional-type guide 300 described above but incorporates additional structure 802 that engages the incisal edge 804 of a model tooth 212. Those structures 802 continue then over the incisal edge 804 to gain a purchase on the lingual side 810 of a model tooth 212. A laboratory specialist may be required to do some pushing of model teeth 212 to urge them into full engagement with such a guide 800. Once engaged though, the guide 800 achieves full control of the model teeth 212. Firmly seating such a guide 800 on the warmed physical model transfers all of the intended torque considerations to the model teeth 212 even though rotation correction may still require that the laboratory specialist push some model teeth 212 laterally.

A guide that includes structure engaging the incisal edges of the teeth (e.g., as shown in FIG. 26) or embodiments of guides such as those shown in FIGS. 11-12 or FIG. 13 can be divided in half or into one anterior portion with a left and right portion for a total of three portions. Such a split guide may have registration features allowing all three (or more) parts to be confined in alignment during use. Even though it is anticipated that all guide configurations (e.g., the guide 250 FIG. 11-12, the guide 300 FIG. 13, or the guide 800 FIG. 26) may be processed in halves or in quadrants, it is a thicker guide 800 incorporating occlusal and some lingual anatomy that may most benefit in use by being split into multiple portions. The primary function of such a guide 800 is to incorporate full grasping of the model tooth 212 so that any combination of uprighting and rotation is handled more by the mechanical engagement of the guide 800 with the teeth 212 than the technician's ability to apply sufficient forces for an adequate period of time while the roots to swing through the heated wax and normalize there.

The configuration of such a guide 800 is shown in the cross sectional view of FIG. 26 through one tooth 212. The reader will understand that all of the teeth 212 would be engaged in the same manner as shown. For those teeth 212 that are to be moved lingually, such a grasping would have the guide 800 contact the lingual side of a tooth, pass over the occlusal and grasp a small portion of the labial or buccal surface. Such a guide 800 may involve special CAD techniques generally referred to as offset surfacing.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed:

1. A method of fabricating an orthodontic aligner for a patient, comprising the steps of:
acquiring a physical model of a dental arch of a patient, said dental arch comprising a plurality of teeth;
producing a virtual model of a patient's dental arch, said virtual model comprising a plurality of virtual teeth that correspond with said plurality of teeth of said dental arch of said patient;
processing said virtual model to accommodate individual movement of at least one of said plurality of virtual teeth;
creating a first activated iteration of said virtual model and comprising moving each member of a first virtual tooth set that comprises at least one of said plurality of virtual teeth;
producing a first positioning guide from said first activated iteration of said virtual model;
creating a first activated iteration of said physical model using said first positioning guide being applied to said physical model; and
fabricating a first aligner based upon said first activated iteration of said physical model.

2. The method of claim 1, wherein said acquiring step comprises receiving said physical model from an orthodontist.

3. The method of claim 2, wherein said acquiring step comprises producing said physical model.

4. The method of claim 1, wherein said physical model comprises a plurality of model teeth that correspond with said plurality of teeth of said dental arch of said patient, said method further comprising:
processing said physical model to accommodate individual movement of at least one of a plurality of model teeth of said physical model.

5. The method of claim 4, wherein said processing said physical model step comprises resetting said physical model.

6. The method of claim 5, wherein said processing said physical model step comprises processing said physical model to accommodate individual movement of each of said plurality of model teeth.

7. The method of claim 6, further comprising:
producing a template aligner for said physical model prior to said processing said physical model step;
positioning said template aligner on said physical model after said processing said physical model step, wherein said positioning said template aligner step comprises presenting said plurality of model teeth at least substantially in a position corresponding with a position of said plurality of model teeth prior to said processing said physical model step.

8. The method of claim 7, wherein said creating a first activated iteration of said physical model step comprises individually engaging each said model tooth, whose corresponding said virtual tooth was moved by said creating a first activated iteration of said virtual model step, and manually moving the same into engagement with a corresponding portion of said first positioning guide.

9. The method of claim 8, wherein said creating a first activated iteration of said physical model step comprises moving each said model tooth, whose corresponding said virtual tooth was moved by said creating a first activated iteration of said virtual model step, into engagement with either a facially-disposed reference datum of said first positioning guide or a lingually-disposed reference datum of said first positioning guide.

10. The method of claim 9, wherein said each said facially-disposed reference datum of said first positioning guide and each said lingually-disposed reference datum of said first positioning guide corresponds with an entire mesio-distal extent of the corresponding said model tooth.

11. The method of claim 7, wherein said creating a first activated iteration of said physical model step comprises moving at least some of said plurality of model teeth during and responsive to applying said first positioning guide to said physical model.

12. The method of claim 11, wherein said first positioning guide comprises a continuous cavity that captures each of said plurality of model teeth after said applying step.

13. The method of claim 12, wherein said first positioning guide comprises an anterior section, a first posterior section for a first arch side of said physical model, and a second posterior section for a second arch side of said physical model, wherein said anterior section, said first posterior section, and said second posterior section are independently movable.

14. The method of claim 12, wherein only a first portion of said plurality of virtual teeth are moved by said creating a first activated iteration of said virtual model step, wherein a remainder of said plurality of virtual teeth remain in an original position for said first activated iteration of said virtual model, and wherein said method further comprises the step of:
registering said first positioning guide to said physical model prior to execution of said creating a first activated iteration of said physical model step, said registering step comprising disposing said first positioning guide in interfacing relation with each said model tooth, whose corresponding said virtual tooth is within said remainder.

15. The method of claim 14, wherein said first positioning guide interfaces with an entire mesio-distal extent of each said model tooth, whose corresponding said virtual tooth is within said remainder, on at least one of a facial side and a lingual side of said model tooth.

16. The method of claim 14, wherein said first positioning guide interfaces with an entire mesio-distal extent of each said model tooth, whose corresponding said virtual tooth is within said remainder, on only one of a facial side and a lingual side of said model tooth.

17. The method of claim 1, wherein said producing a virtual model step comprises scanning at least one of said dental arch of said patient and said physical model.

18. The method of claim 17, wherein said producing a virtual model step comprises acquiring a data set that at least substantially replicates said dental arch of said patient.

19. The method of claim 1, wherein said first positioning guide has a thickness of no more than about 1 mm (0.040″), wherein said thickness is defined by an occlusal/gingival dimension when said first positioning guide is applied to said physical model.

20. The method of claim 1, further comprising:
producing a second positioning guide from said first activated iteration of said virtual model, wherein said creating a first activated iteration of said physical model step comprises applying each of said first and second positioning guides to said physical model.

21. The method of claim 20, wherein said first and second positioning guides are spaced in an occlusal/gingival dimension when applied to said physical model.

22. The method of claim 1, wherein said producing a first positioning guide step comprises creating a two-dimensional first positioning guide.

23. The method of claim 22, wherein said first positioning guide has a thickness within a range of about 2 mm to about 3 mm, wherein said thickness is defined by an occlusal/gingival dimension when said first positioning guide is applied to said physical model.

24. The method of claim 23, wherein said producing a first positioning guide step comprises creating at least one two-dimensional reference datum on said first positioning guide for each model tooth of said physical model.

25. The method claim 1, wherein said producing a first positioning guide step comprises providing a corresponding occlusal surface and at least one of a lingual surface and a facial surface for each said physical tooth of said physical model.

26. The method of claim 25, wherein said producing a first positioning guide step comprises creating a cavity for each said model tooth of said physical model that is defined by at least occlusal and lingual surfaces.

27. The method of claim 26, wherein said producing a first positioning guide step comprises creating a three-dimensional cavity such that each model tooth of said physical model is disposed with a corresponding portion of said three-dimensional cavity by said creating a first activated iteration of said physical model step.

28. The method of claim 1, wherein said creating a first activated iteration of said physical model step comprises registering said first positioning guide to said physical model using at least one model tooth of said physical model that is not being moved by said creating a first activated iteration of said physical model step.
